(19) United States
(12) Patent Application Publication
(10) Pub. No.: US 2003/0226014 A1
(43) Pub. Date: Dec. 4, 2003

(54) Trusted client utilizing security kernel under secure execution mode

(76) Inventors: Rodney W. Schmidt, Dripping Springs, TX (US); Brian C. Barnes, Round Rock, TX (US); Geoffrey S. Strongin, Austin, TX (US); David S. Christie, Austin, TX (US)

Correspondence Address: WILLIAMS, MORGAN & AMERSON, P.C., 10333 RICHMOND, SUITE 1100, HOUSTON, TX, 77042, US

(21) Appl. No.: 10/160,984

(22) Filed: May 31, 2002

(51) Int. Cl. H04L 9/00

(52) U.S. Cl. 713/164

(57) ABSTRACT

A method and system for performing the method. a method is provided. The method includes executing an insecure routine and receiving a request from the insecure routine. The method also includes performing a first evaluation of the request in hardware, and performing a second evaluation of the request in a secure routine in software. The computer system includes a processor configurable to execute a secure routine and an insecure routine. The computer system also includes hardware coupled to perform a first evaluation of a request associated with the insecure routine. The hardware is further configured to provide a notification of the request to the secure routine. The secure routine is configured to perform a second evaluation of the request. The secure routine is further configured to deny a requested response to the request.

### BACKGROUND OF THE INVENTION

1. Field of the Invention

This invention relates generally to memory management systems and methods, and, more particularly, to memory management systems and methods that provide a secure computing environment.

2. Description of the Related Art

FIG. 1 is a diagram of an exception stack frame 100 produced by an x86 processor, such as when running the Windows® operating system (Microsoft Corp., Redmond, Wash.). On entry to an exception handler, all registers of the application program in which the exception occurred (i.e., the “faulting application”) are preserved except the code segment (CS), instruction pointer (EIP), stack segment (SS), stack pointer (ESP) registers, and EFLAGS. The contents of these registers are made available in the exception stack frame 100.

The exception stack frame 100 begins at segmented address SS:ESP. The error code resides in the exception stack frame 100 at segmented address SS:ESP+00 h. The contents of the instruction pointer (EIP) register of the faulting application resides in the exception stack frame 100 at segmented address SS:ESP+04 h. The contents of the code segment (CS) register of the faulting application resides in the exception stack frame 100 at segmented address SS:ESP+08 h. The contents of the flags (EFLAGS) register of the faulting application resides in the exception stack frame 100 at segmented address SS:FSP+0 Ch. The contents of the stack pointer (ESP) register of the faulting application resides in the exception stack frame 100 at segmented address SS:ESP+10 h. The contents of the stack segment (SS) register of the faulting application resides in the exception stack frame 100 at segmented address SS:ESP+14 h. Note that the ESP and SS values appear in the exception stack frame 100 if the associated control transfer to the exception handler involves a change of privilege level.

The contents of the instruction pointer (EIP) register of the faulting application, at segmented address SS:ESP+04 h, points to the instruction in the faulting application that generated the exception. The contents of the stack pointer (ESP) register of the faulting application, at segmented address SS:ESP+10 h, is the address of (i.e., points to) the faulting applications' stack frame at fault time.

The error code for segment-related exceptions is very similar to a protected mode selector. The highest-ordered 13 bits (bits 15:3) are the selector index, and bit 2 is the table index. However, instead of a requestor privilege level (RPL), bits 0 and 1 have the following meeting: bit 0 (EXT) is set if the fault was caused by an event external to the program, and bit 1 (IDT) is set if the selector index refers to a gate descriptor in the IDT.

FIG. 2 is a diagram of a SYSCALL/SYSRET target address register (STAR) 200 used in x86 processors manufactured by Advanced Micro Devices, Inc. The SYSCALL/SYSRET target address register (STAR) 200 includes a “SYSRET CS Selector and SS Selector Base” field, a “SYSCALL CS Selector and SS Selector Base” field, and a “Target EIP Address” field.

At some point prior to execution of a SYSCALL instruction, the operating system writes values for the code segment (CS) of the appropriate system service code to the SYSCALL CS Selector and SS Selector Base field of the SYSCALL/SYSRET target address register (STAR) 200. The operating system also writes the address of the first instruction within the system service code to be executed into the Target EIP Address field of the SYSCALL/SYSRET target address register (STAR) 200. The STAR register is configured at system boot. The Target EIP address may point to a fixed system service region in the operating system kernel.

During execution of a SYSCALL instruction, the contents of the SYSCALL CS Selector and SS Selector Base field is copied into the CS register. The contents of the SYSCALL CS Selector and SS Selector Base field, plus the value ‘1000b’, is copied into the SS register. This effectively increments the index field of the CS selector such that a resultant SS selector points to the next descriptor in a descriptor table, after the CS descriptor. The contents of the Target EIP Address field are copied into the instruction pointer (EIP) register, and specify an address of a first instruction to be executed.

At some point prior to execution of a SYSRET instruction corresponding to the SYSCALL instruction, the operating system writes values for the code segment (CS) of the calling code to the SYSRET CS Selector and SS Selector Base field of the SYSCALL/SYSRET target address register (STAR) 200. The SYSRET instruction obtains the return EIP address from the ECX register.

### SUMMARY OF THE INVENTION

According to one aspect of the present invention, a method is provided. The method includes executing an insecure routine and receiving a request from the insecure routine. The method also includes performing a first evaluation of the request in hardware, and performing a second evaluation of the request in a secure routine in software.

According to another aspect of the present invention, a computer system is provided. The computer system includes a processor configurable to execute a secure routine and an insecure routine. The computer system also includes hardware coupled to perform a first evaluation of a request associated with the insecure routine. The hardware is further configured to provide a notification of the request to the secure routine. The secure routine is configured to perform a second evaluation of the request. The secure routine is further configured to deny a requested response to the request.

### BRIEF DESCRIPTION OF THE DRAWINGS

The invention may be understood by reference to the following description taken in conjunction with the accompanying drawings, in which like reference numerals identify similar elements, and in which:

FIG. 1 is a diagram of a an exception stack frame produced by an x86 processor, such as when running the Windows® operating system;

FIG. 2 is a diagram of a SYSCALL/SYSRET target address register;

FIG. 3 is a diagram of one embodiment of a system in accordance with one aspect of the present invention;

FIG. 4A is a block diagram of one embodiment of a computer system that may be utilized in accordance with one aspect of the present invention;

FIG. 4B is a diagram of one embodiment of a computer system including a central processing unit including an input/output (I/O) security check unit (SCU) used to protect the device hardware units from unauthorized accesses generated by the CPU in accordance with one aspect of the present invention;

FIG. 4C is a diagram of one embodiment of a computer system including a CPU including a CPU security check unit (SCU) and a host bridge including a host bridge SCU in accordance with one aspect of the present invention;

FIG. 5A is a diagram illustrating some relationships between various hardware and software components of the computer system embodiments, according to one aspect of the present invention;

FIG. 5B is another diagram illustrating some relationships between various hardware and software components of the computer system embodiments, according to one aspect of the present invention;

FIG. 5C is another diagram illustrating some relationships between various hardware and software components of the computer system embodiments, according to one aspect of the present invention;

FIG. 6A is a diagram of one embodiment of a CPU, according to one aspect of the present invention;

FIG. 6B is a diagram of another embodiment of a CPU, according to one aspect of the present invention;

FIG. 6C is a diagram of another embodiment of a CPU, according to one aspect of the present invention;

FIG. 7 is a diagram of one embodiment of a MMU including a paging unit having a CPU SCU, according to one aspect of the present invention;

FIG. 8A is a diagram illustrating one embodiment of the I/O SCU, according to one aspect of the present invention;

FIG. 8B is a diagram of one embodiment of the CPU SCU, according to one aspect of the present invention;

FIG. 9 is a diagram of an embodiment of a secure mode SMCALL/SMRET target address register (SMSTAR) and a secure mode GS base (SMGSBASE) register used to handle secure execution mode (SEM) exceptions, according to one aspect of the present invention;

FIG. 10A is a diagram of one embodiment of an SEM exception stack frame generated when an SEM exception occurs, according to one aspect of the present invention;

FIG. 10B is a diagram of an exemplary format of the error code of the SEM exception stack frame, according to one aspect of the present invention;

FIG. 11 illustrates a flowchart of an embodiment of a method of handling a secure execution mode exception, according to one aspect of the present invention;

FIG. 12 is a diagram incorporating various embodiments for maintaining security in the computer system, according to various aspects of the present invention;

FIG. 13 is a diagram of one embodiment of a mechanism for accessing a security attribute table (SAT) entry of a selected memory page in order to obtain additional security information of the selected memory page, according to one aspect of the present invention;

FIG. 14A is a diagram of one embodiment of a SAT default register, according to one aspect of the present invention;

FIG. 14B is a diagram of one embodiment of a SAT directory entry format, according to one aspect of the present invention;

FIG. 15 is a diagram of one embodiment of a SAT entry format, according to one aspect of the present invention;

FIG. 16A is a diagram of one embodiment of the host bridge, including the host bridge SCU, according to one aspect of the present invention;

FIG. 16B is, according to one aspect of the present invention;

FIG. 17 is a diagram of one embodiment of the host bridge SCU, according to one aspect of the present invention;

FIG. 18 is a diagram of another embodiment of host bridge SCU, including an access authorization table, according to one aspect of the present invention;

FIG. 19 is a more detailed block diagram representation of a processing unit shown in FIG. 2, in accordance with one embodiment of the present invention, according to one aspect of the present invention;

FIG. 20 is a more detailed block diagram representation of an I/O access interface shown in FIG. 19, in accordance with one embodiment of the present invention;

FIGS. 21A and 22B illustrate block diagram representations of an I/O-space/I/O-memory access performed by the processor illustrated in FIGS. 19-20, according to various aspects of the present invention;

FIG. 22 is a diagram illustrating one embodiment of an SEM I/O permission bitmap stored within a memory, and one embodiment of a mechanism for accessing the SEM I/O permission bitmap, according to various aspects of the present invention;

FIG. 23 is a diagram illustrating another embodiment of the SEM I/O permission bitmap of FIG. 22, and another embodiment of the mechanism for accessing the SEM I/O permission bitmap, according to various aspects of the present invention;

FIG. 24 is a diagram illustrating relationships between the various hardware and software components of a computer system, wherein a first device driver and a corresponding first device hardware unit reside in a first security “compartment,” and a second device driver and a corresponding second device hardware unit reside in a second security compartment separate, and operationally isolated from, the first security compartment, according to one aspect of the present invention; and

FIG. 25 illustrates a flowchart of an embodiment of a method of operating the computer system for improved security, according to one aspect of the present invention.

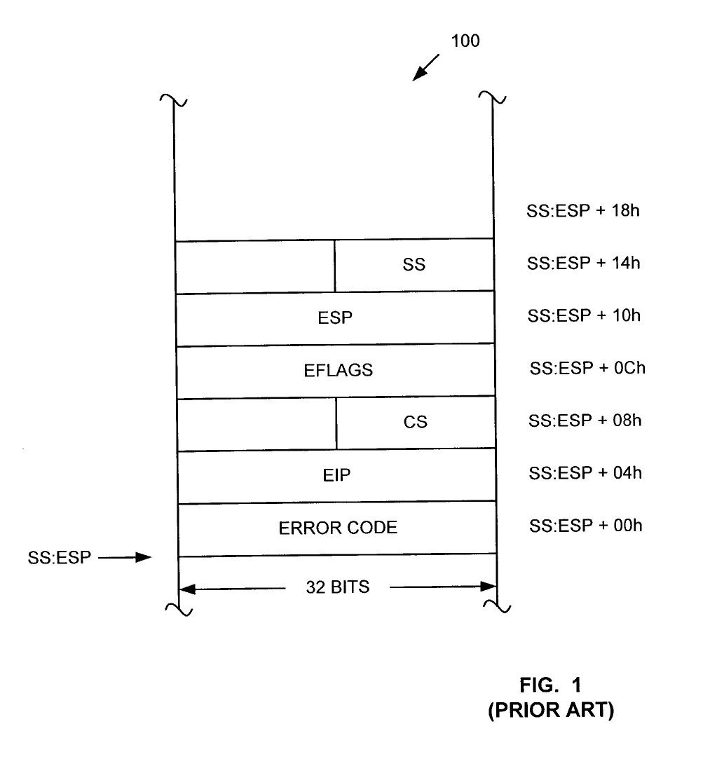

### THE METHOD

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

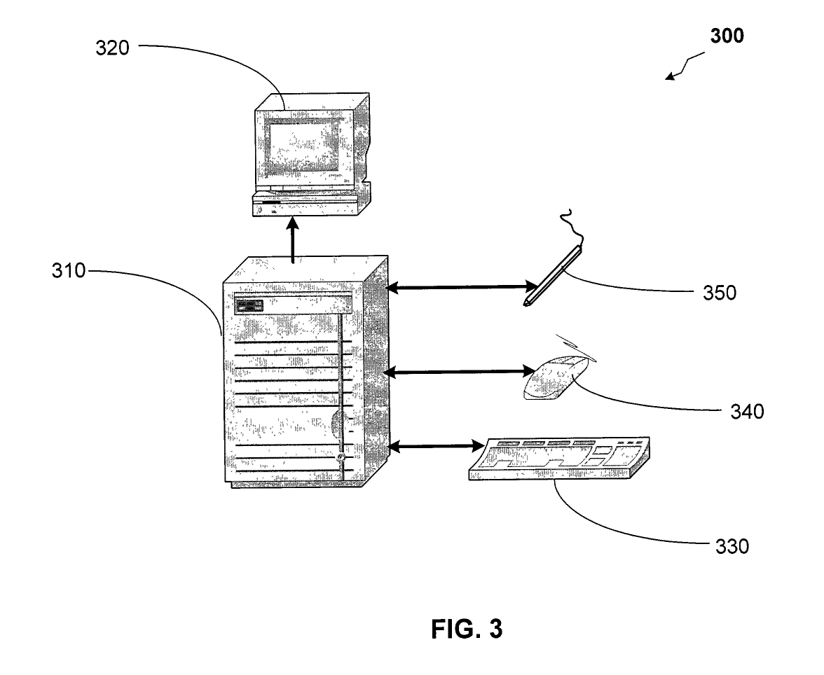

Turning now to FIG. 3, one embodiment of a system 300 in accordance with the present invention is illustrated. The system 300 comprises a processing unit 310; a plurality of input/output devices, such as a keyboard 330, a mouse 340, an input pen 350; and a display unit 320, such as a monitor. The security level system disclosed by the present invention, in one embodiment, resides in the processing unit 310. According to one aspect of the present invention, an input from one of the input/output devices 330, 340, 350 may initiate the execution of one or more software structures, including the operating system, in the processing unit 310. I/O space and/or memory associated with an I/O space residing in the system 300 is then accessed to execute the various software structures residing in the processing unit 310. Embodiments of the present invention may restrict I/O space accesses that are initiated by one or more software structures, based upon predetermined security entries programmed into the system 300.

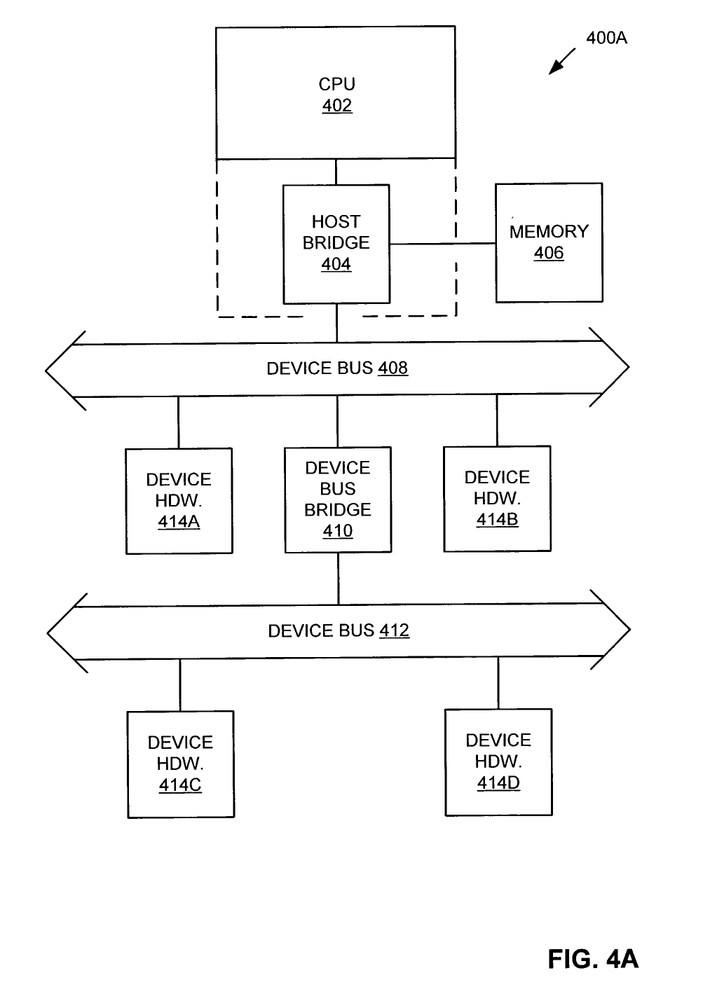

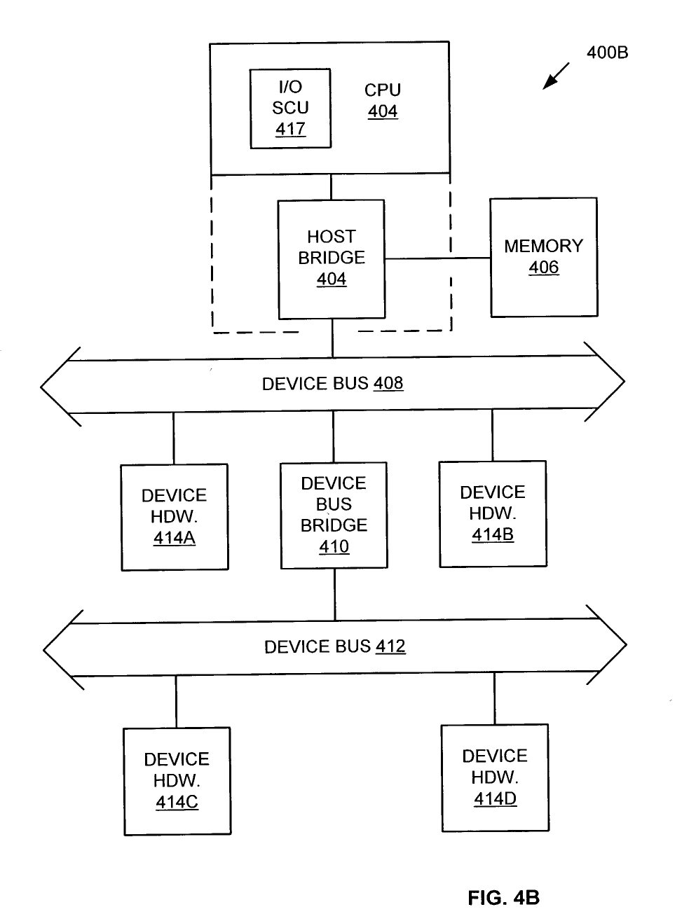

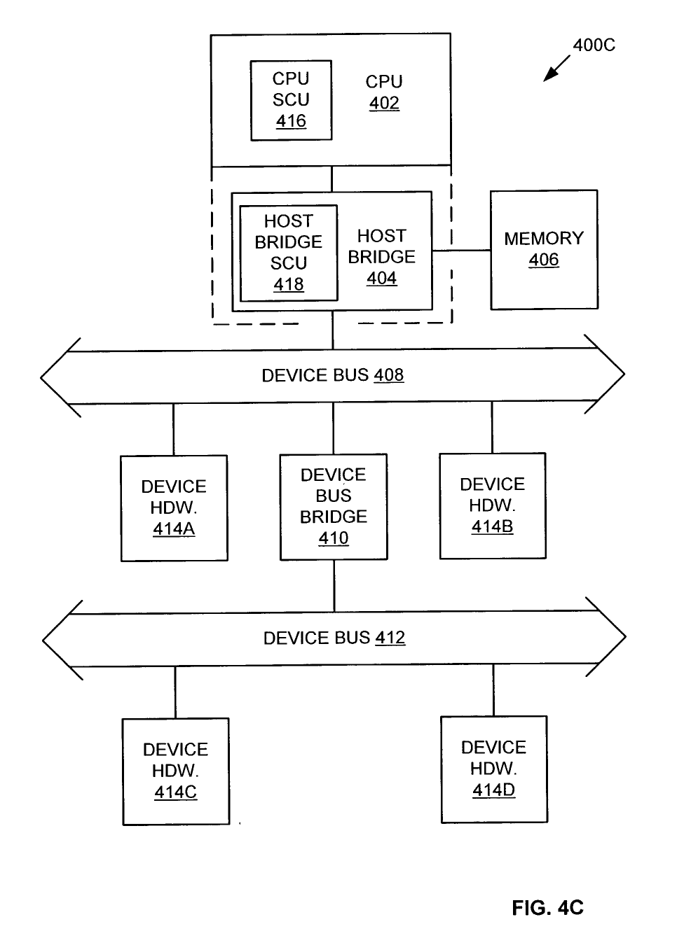

FIG. 4A is a diagram of one embodiment of a computer system 400A including a CPU 402, a system or “host” bridge 404, a memory 406, a first device bus 408 (e.g., a peripheral component interconnect or PCI bus), a device bus bridge 410, a second device bus 412 (e.g., an industry standard architecture or ISA bus), and four device hardware units 414A-414D. The host bridge 404 is coupled to the CPU 402, the memory 406, and the first device bus 408. The host bridge 404 translates signals between the CPU 402 and the first device bus 408, and operably couples the memory 406 to the CPU 402 and to the first device bus 408. The device bus bridge 410 is coupled between the first device bus 408 and the second device bus 412 and translates signals between the first device bus 408 and the second device bus 412.

In the embodiment of FIG. 4A, the device hardware units 414A and 414B are coupled to the first device bus 408, and the device hardware units 414C and 414D are coupled to the second device bus 412. One or more of the device hardware units 414A-414D may be, for example, storage devices (e.g., hard disk drives, floppy drives, and CD-ROM drives), communication devices (e.g., modems and network adapters), or input/output devices (e.g., video devices, audio devices, and printers). It is noted that in other embodiments, the host bridge 404 may be part of the CPU 402 as indicated in FIG. 4A.

In the embodiment of FIG. 4B, the CPU 404 includes an input/output (I/O) security check unit (SCU) 415. The device hardware units 414A-414D may be mapped to various I/O ports of the I/O space of the CPU 404, and the CPU 404 may communicate with the device hardware units 414A-414D via corresponding I/O ports. In this situation, the I/O SCU 415 is used to protect the device hardware units 414A-414D from unauthorized accesses generated by the CPU 404. It is noted that in other embodiments, the host bridge 404 may be part of the CPU 404 as indicated in FIG. 4B.

In the embodiment of FIG. 4C, CPU 402 includes a CPU security check unit (SCU) 416, and host bridge 404 includes a host bridge SCU 418. As will be described in detail below, the CPU SCU 416 protects the memory 406 from unauthorized accesses generated by CPU 402 (i.e., “software-initiated accesses”), and the host bridge SCU 418 protects memory 406 from unauthorized accesses initiated by device hardware units 414A-414D (i.e., “hardware-initiated accesses”).

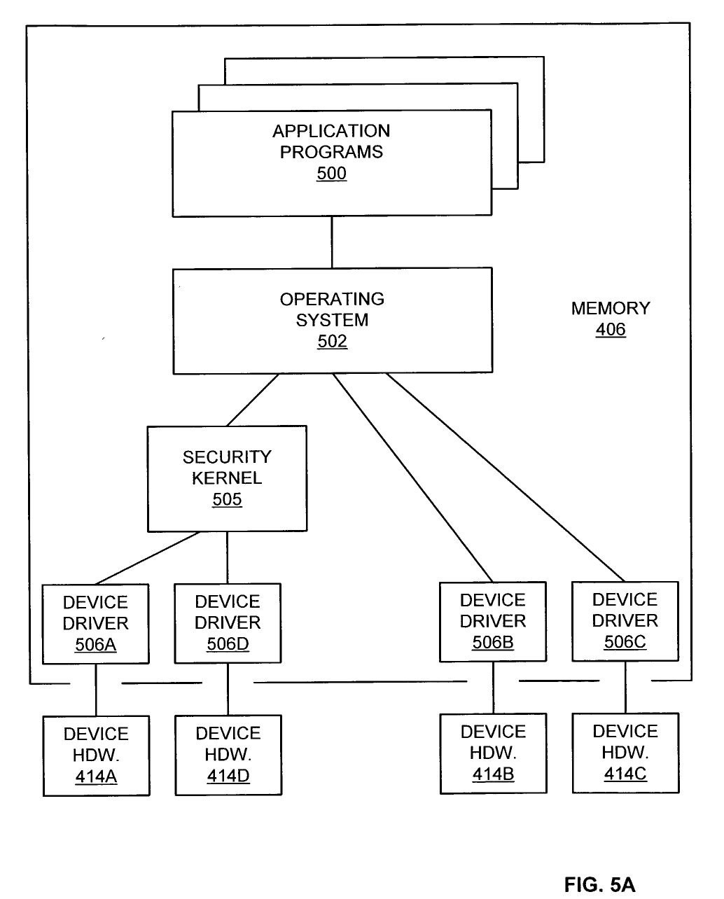

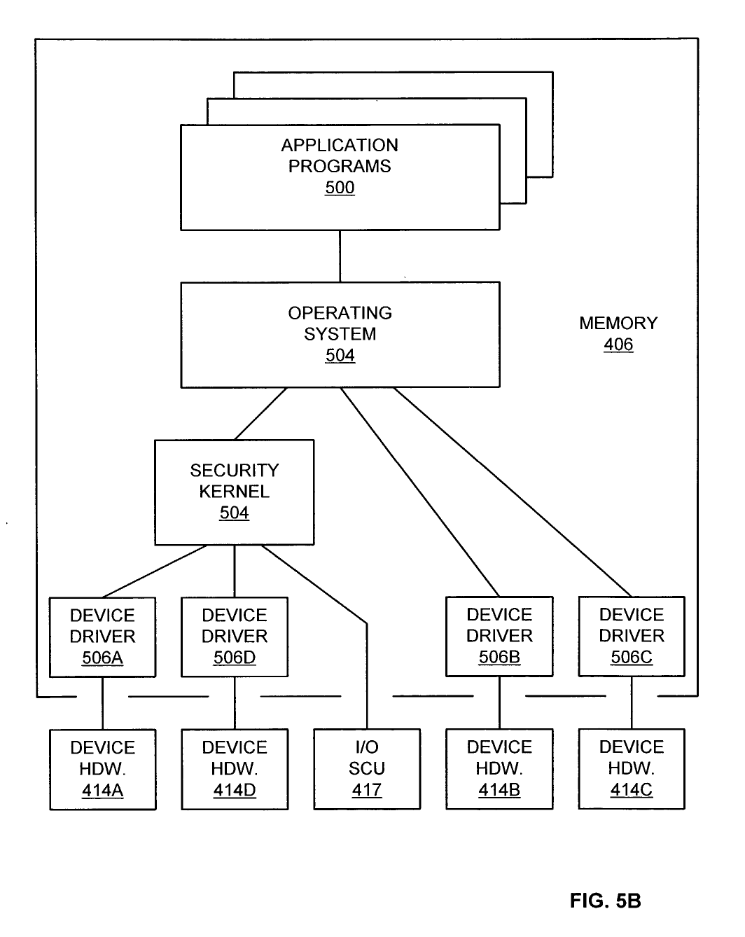

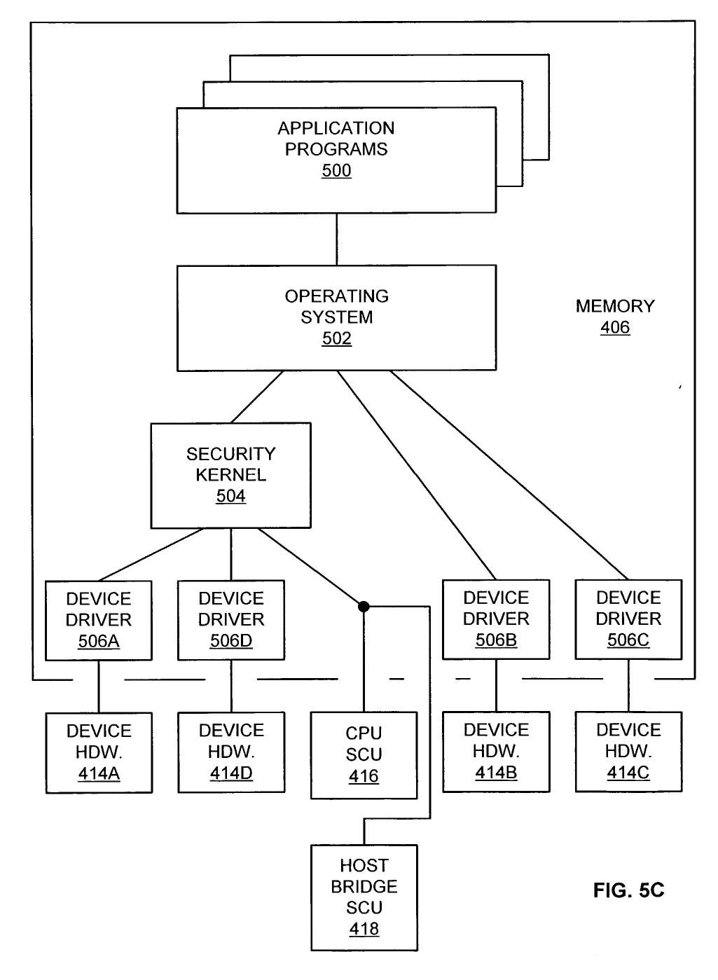

FIG. 5A is a diagram illustrating relationships between various hardware and software components of the computer system 400 of FIGS. 4A or 4B. In the embodiment of FIG. 5, multiple application programs 500, an operating system 502, a security kernel 504, and device drivers 506A-506D are stored in the memory 406. The application programs 500, the operating system 502, the security kernel 504, and the device drivers 506A-506D include instructions executed by the CPU 402. The operating system 502 provides a user interface and software “platform” on top of which the application programs 500 run. The operating system 502 may also provide, for example, basic support functions, including file system management, process management, and input/output (I/O) control.

The operating system 502 may also provide basic security functions. For example, the CPU 402 may be an x86 processor that executes instructions of the x86 instruction set. In this situation, the CPU 402 may include specialized hardware elements to provide both virtual memory and physical memory protection features in the protected mode as described above. The operating system 502 may be, for example, one of the Windows® family of operating systems that operates the CPU 402 in the protected mode, and uses the specialized hardware elements of the CPU 402 to provide both virtual memory and memory protection in the protected mode. The security kernel 504 provides additional security functions above the security functions provided by the operating system 502, e.g., to protect data stored in the memory 406 from unauthorized access.

In the embodiment of FIG. 5A, the device drivers 506A-506D are operationally associated with, and coupled to, the respective corresponding device hardware units 414A-414D. The device hardware units 414A and 414D may be, for example, “secure” devices, and the corresponding device drivers 506A and 506D may be “secure” device drivers. The security kernel 504 is coupled between the operating system 502 and the secure device drivers 506A and 506D, and may monitor all accesses by the application programs 500 and the operating system 502 to secure the device drivers 506A and 506D and the corresponding secure devices 414A and 414D. The security kernel 504 may prevent unauthorized accesses to the secure device drivers 506A and 506D and the corresponding secure devices 414A and 414D by the application programs 500 and the operating system 502. The device drivers 506B and 506C, on the other hand, may be “non-secure” device drivers, and the corresponding device hardware units 414B and 414C may be “non-secure” device hardware units. The device drivers 506B and 506C and the corresponding device hardware units 414B and 414C may be, for example, “legacy” device drivers and device hardware units.

It is noted that in other embodiments, the security kernel 504 may be part of the operating system 502. In yet other embodiments, the security kernel 504, the device drivers 506A and 506D, and/or the device drivers 506B and 506C may be part of the operating system 502.

As indicated in FIG. 5B, the security kernel 504 may be coupled to the I/O SCU 417. As will be described in detail below, the I/O SCU 216 monitors all software-initiated accesses to the I/O ports in the I/O address space, and allows only authorized accesses to the I/O ports.

As indicated in FIG. 5C, security kernel 504 is coupled to CPU SCU 416 and host bridge SCU 418 (e.g., via one or more device drivers). As will be described in detail below, CPU SCU 416 and host bridge SCU 418 control accesses to memory 406. CPU SCU 416 monitors all software-initiated accesses to memory 406, and host bridge SCU 418 monitors all hardware-initiated accesses to memory 406. Once configured by security kernel 504, CPU SCU 416 and host bridge SCU 418 allow only authorized accesses to memory 406 and I/O space. Note that in one embodiment, the CPU SCU 416 protects register space.

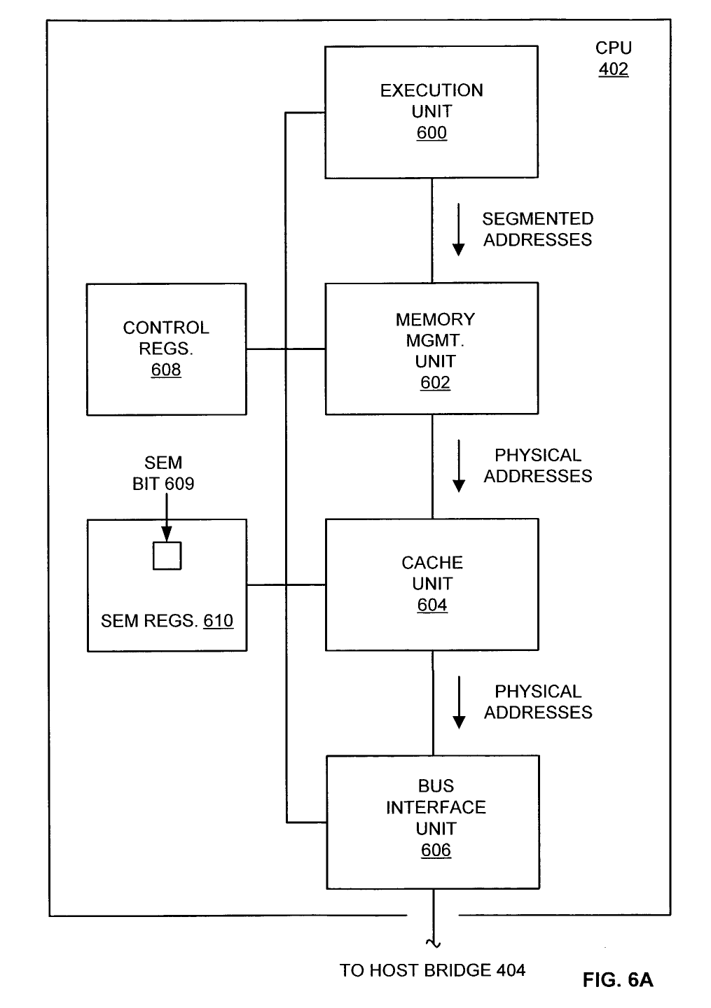

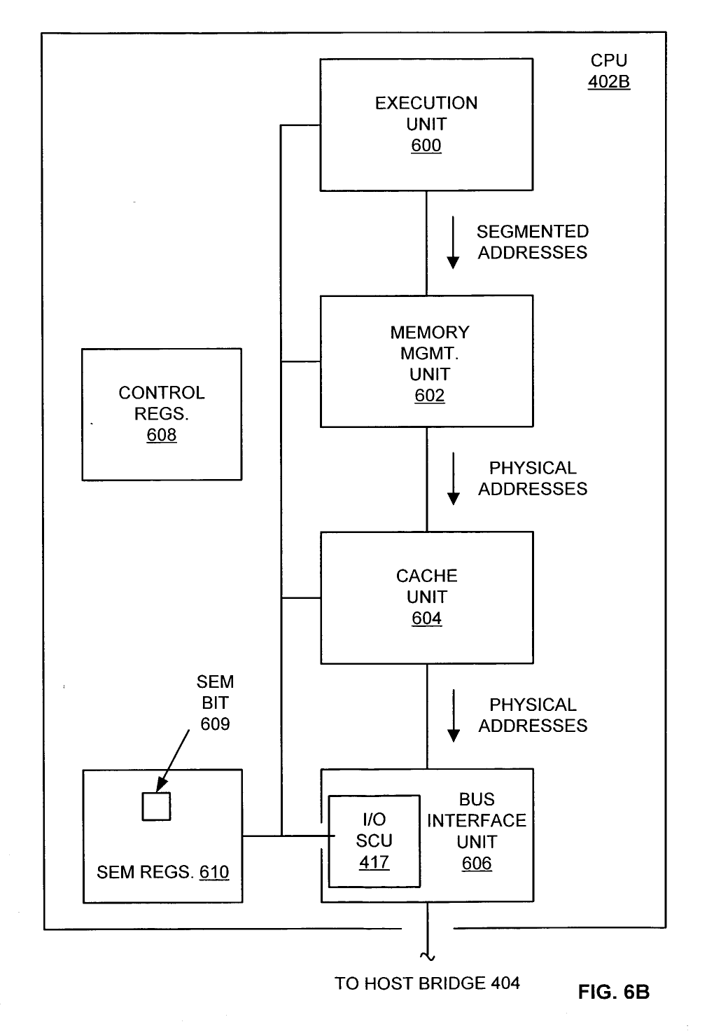

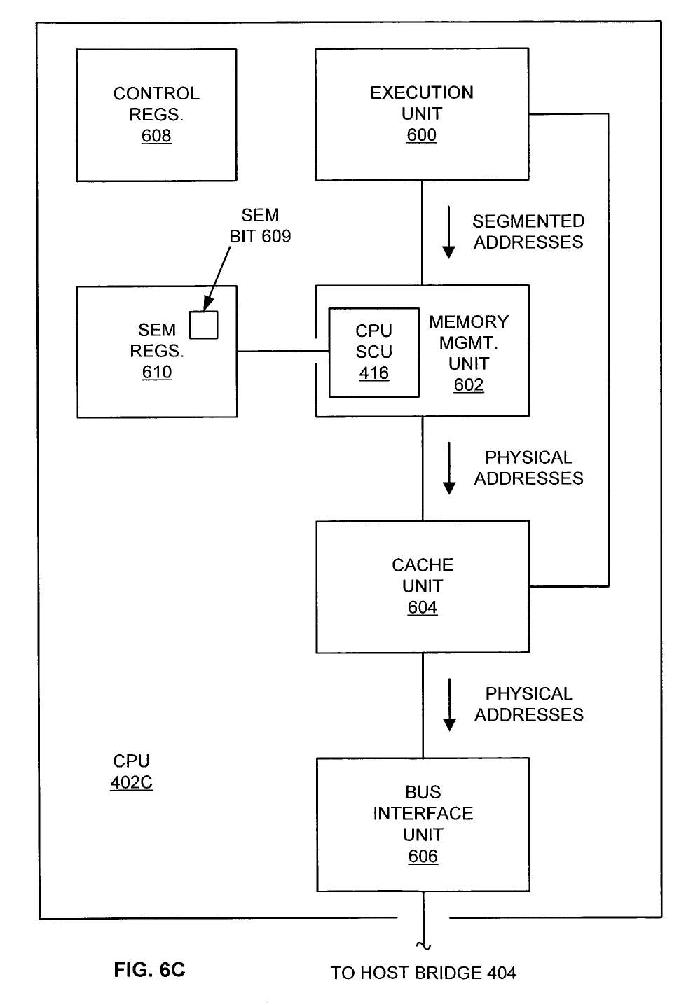

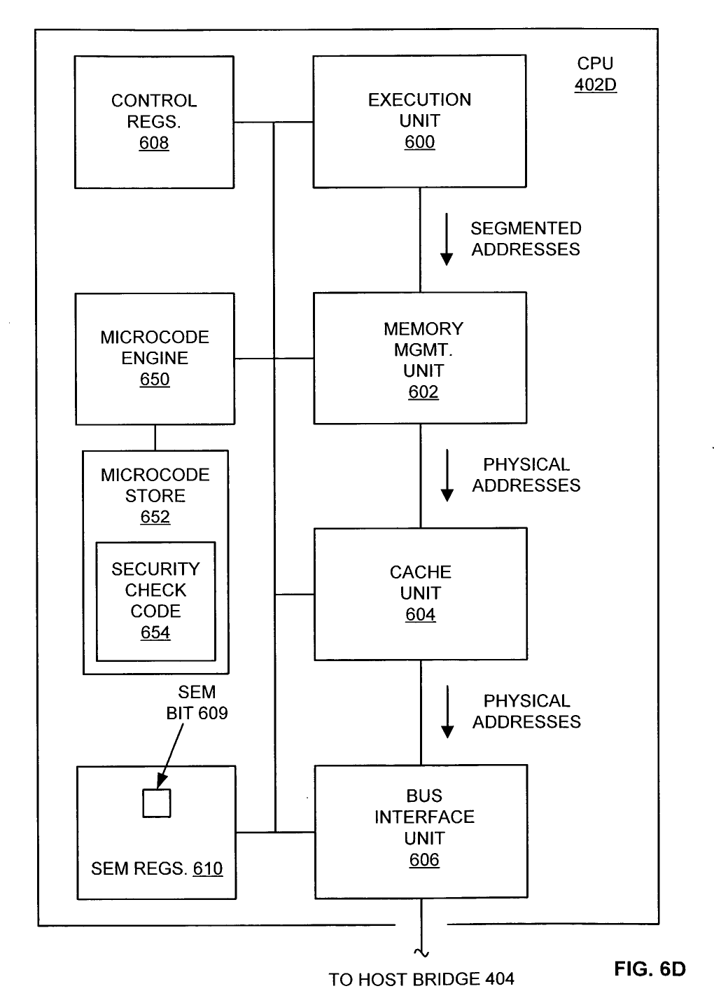

FIG. 6A is a diagram of one embodiment of the CPU 402 of the computer system 400A of FIG. 4A. In the embodiment of FIG. 6A, the CPU 402 A includes an execution unit 600, a memory management unit (MMU) 602, a cache unit 604, a bus interface unit (BIU) 606, a set of control registers 608, and a set of secure execution mode (SEM) registers 610. The set of SEM registers 610 may be used to implement a secure execution mode (SEM) within the computer system 400A of FIG. 4A. The SEM registers 610 are accessed (i.e., written to and/or read from) by the security kernel 504.

In the embodiment of FIG. 6A, the set of SEM registers 610 includes a secure execution mode (SEM) bit 609. The computer system 400A of FIG. 4A may, for example, operate in the secure execution mode (SEM) when: (i) the CPU 402 is an x86 processor operating in the x86 protected mode, (ii) memory paging is enabled, and (iii) the SEM bit is set to ‘1’. Other methods of indicating operation in SEM and other operations of SEM may also be used.

In general, the contents of the set of control registers 608 are used to govern operation of the CPU 402. Accordingly, the contents of the set of control registers 608 are used to govern operation of the execution unit 600, the MMU 602, the cache unit 604, and/or the BIU 606. The set of control registers 608 may include, for example, the multiple control registers of the x86 processor architecture.

The execution unit 600 of the CPU 402 fetches instructions (e.g., x86 instructions) and data, executes the fetched instructions, and generates signals (e.g., address, data, and control signals) during instruction execution. The execution unit 600 is coupled to the cache unit 604 and may receive instructions from the memory 406 via the cache unit 604 and the BIU 606. Note that the execution unit 600 may execute standard instructions, secure instructions, and/or microcode, depending on the implementation. In one embodiment, microcode executing in the processor 402 is hardware and not software.

The memory 406 (e.g., FIG. 4A) of the computer system 400A includes multiple memory locations, each having a unique physical address. When operating in protected mode with paging enabled, an address space of the CPU 402 is divided into multiple blocks called page frames or “pages.” In other embodiments, the memory may be divided into or accessed through memory regions defined differently. Typically, only data corresponding to a portion of the pages is stored within the memory 406 at any given time.

In the embodiment of FIG. 6A, address signals generated by the execution unit 600 during instruction execution represent segmented (i.e., “logical”) addresses. The MMU 602 translates the segmented addresses generated by the execution unit 600 to corresponding physical addresses of the memory 406. The MMU 602 provides the physical addresses to the cache unit 604. The cache unit 604 is a relatively small storage unit used to store instructions and data recently fetched by the execution unit 600. The BIU 606 is coupled between the cache unit 604 and the host bridge 404, and is used to fetch instructions and data not present in the cache unit 604 from the memory 406 via the host bridge 404. Note that the use of a cache unit 604 is optional but may advantageously provide for greater operational efficiency of the CPU 402.

When the computer system 400A of FIG. 4A operates in the SEM, the security kernel 505 generates and maintains one or more security attribute data structures (e.g., tables) in the memory 406. Each memory page has a corresponding security context identification (SCID) value, and the corresponding SCID value may be stored within the security attribute data structures. The MMU 602 uses an address generated during instruction execution (e.g., a physical address) to access the one or more security attribute data structures to obtain the SCIDs of corresponding memory pages. In general, the computer system 400A has n different SCID values, where n is an integer and n≧1.

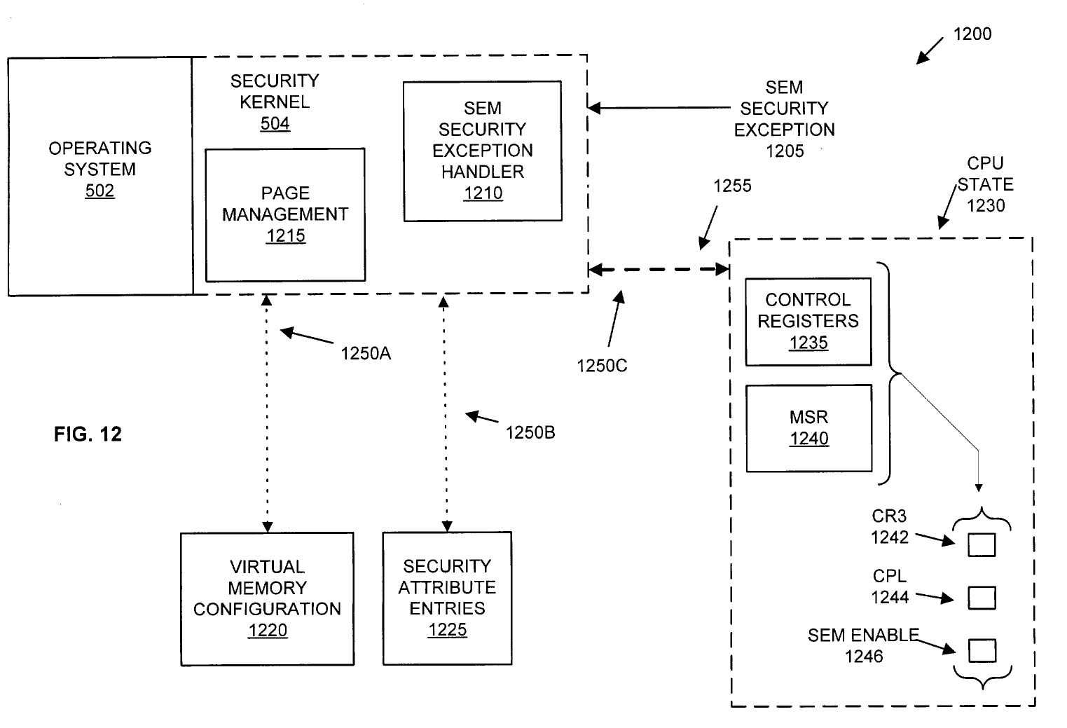

When the computer system 400A of FIG. 4A operates in the SEM, various activities by software that violate security mechanisms will cause an SEM security exception. The SEM security exceptions may be dispatched through a pair of registers (e.g., model specific registers or MSRs) similar to the way x86 “SYSENTER” and “SYSEXIT” instructions operate. The pair of registers may be “security exception entry point” registers, and may define a branch target address for instruction execution when a SEM security exception occurs. The security exception entry point registers may define the code segment (CS), then instruction pointer (IP, or the 64-bit version RIP), stack segment (SS), and the stack pointer (SP, or the 64-bit version RSP) values to be used on entry to an SEM security exception handler 1210 (see FIG. 12).

Under software control, execution unit 600 may push the previous SS, SP/RSP, EFLAGS, CS, and IP/RIP values onto a new stack to indicate where the exception occurred. In addition, execution unit 600 may push an error code onto the stack. It is noted that a normal return from interrupt (IRET) instruction may not be used as the previous SS and SP/RSP values are always saved, and a stack switch is always accomplished, even if a change in a current privilege level (CPL) does not occur. Accordingly, a new instruction may be defined to accomplish a return from the SEM security exception handler 1210 (SMRET).

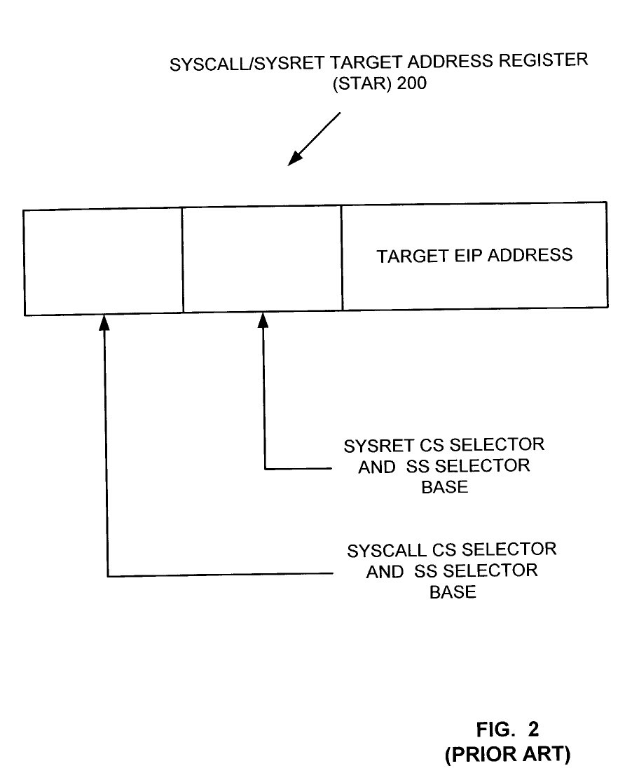

FIG. 6B is a diagram of one embodiment of the CPU 402B of the computer system 400B of FIG. 4B. In the embodiment of FIG. 6A, the CPU 402B includes an execution unit 600, a memory management unit (MMU) 602, a cache unit 604, a bus interface unit (BIU) 606, a set of control registers 608, and a set of secure execution mode (SEM) registers 610. The BIU 606 is coupled the to the host bridge 404 (FIG. 2), and forms an interface between the CPU 402B and the host bridge 404. The BIU 606 is also coupled to the memory 404 (FIG. 2) via the host bridge 404, and forms an interface between the CPU 402B and the memory 404. In the embodiment of FIG. 6A, the I/O SCU 417 is located within the BIU 606.

The set of SEM registers 610 may be used to implement a secure execution mode (SEM) within the computer system 400B of FIG. 4B, and the operation of the I/O SCU 417 is governed by the contents of the set of SEM registers 610. The SEM registers 610 are accessed (i.e., written to and/or read from) by the security kernel 504.

In the embodiment of FIG. 6B, the set of SEM registers 610 includes an SEM bit 609. The computer system 400B of FIG. 4B may, for example, operate in the SEM when: (i) the CPU 402B is an x86 processor operating in the x86 protected mode, (ii) memory paging is enabled, and (iii) the SEM bit is set to ‘1’.

In general, the contents of the set of control registers 608 govern operation of the CPU 402B. Accordingly, the contents of the set of control registers 608 govern operation of the execution unit 600, the MMU 602, the cache unit 604, and/or the BIU 606. The set of control registers 608 may include, for example, the multiple control registers of the x86 processor architecture.

The execution unit 600 of the CPU 402B fetches instructions (e.g., x86 instructions) and data, executes the fetched instructions, and generates signals (e.g., address, data, and control signals) during instruction execution. The execution unit 600 is coupled to the cache unit 604 and may receive instructions from the memory 406 via the cache unit 604 and the BIU 606.

The memory 406 of the computer system 400B includes multiple memory locations, each having a unique physical address. When operating in protected mode with paging enabled, an address space of the CPU 402B is divided into multiple blocks called page frames or “pages.” Other memory units or divisions are also contemplated. Only data corresponding to a portion of the pages is stored within the memory 406 at any given time. In the embodiment of FIG. 6B, address signals generated by the execution unit 600 during instruction execution represent segmented (i.e., “logical”) addresses. The MMU 602 translates the segmented addresses generated by the execution unit 600 to corresponding physical addresses of the memory 406. The MMU 602 provides the physical addresses to the cache unit 604. The cache unit 604 is a relatively small storage unit used to store instructions and data recently fetched by the execution unit 600.

The BIU 606 is coupled between the cache unit 604 and the host bridge 404. The BIU 606 is used to fetch instructions and data not present in the cache unit 604 from the memory 404 via the host bridge 404. The BIU 606 also includes the I/O SCU 417. The I/O SCU 417 is coupled to the SEM registers 610, the execution unit 600, and the MMU 602. As described above, the I/O SCU 417 monitors all software-initiated accesses to the I/O ports in the I/O address space, and allows only authorized accesses to the I/O ports.

FIG. 6C is a diagram of one embodiment of CPU 402C of computer system 400C of FIG. 4C. In the embodiment of FIG. 6C, CPU 402C includes an execution unit 600, a memory management unit (MMU) 602, a cache unit 604, a bus interface unit (BIU) 606, a set of control registers 608, and a set of secure execution mode (SEM) registers 610. CPU SCU 416 is located within MMU 602.

The set of SEM registers 610 may be used to implement the SEM within computer system 400C of FIG. 4C, and operations of CPU SCU 416 and host bridge SCU 418 are governed by the contents of the set of SEM registers 610. The SEM registers 610 are accessed (i.e., written to and/or read from) by security kernel 504. Computer system 400C of FIG. 4C may, for example, operate in the SEM when: (i) CPU 402C is an x86 processor operating in the x86 protected mode, (ii) memory paging is enabled, and (iii) the contents of SEM registers 610 specify SEM operation.

In the embodiment of FIG. 6C, the set of SEM registers 610 includes the SEM bit 609. Operating modes of the computer system 400C include a “normal execution mode” and a “secure execution mode” (SEM). The computer system 400C normally operates in the normal execution mode. The set of SEM registers 610 is used to implement the SEM within the computer system 400C. The SEM registers 610 are accessed (i.e., written to and/or read from) by the security kernel 504. The computer system 400C may, for example, operate in the SEM when: (i) the CPU 402C is an x86 processor operating in the x86 protected mode, (ii) memory paging is enabled, and (iii) the SEM bit 609 is set to ‘1’.

In general, the contents of the set of control registers 608 govern operation of CPU 402C. Accordingly, the contents of the set of control registers 608 govern operation of execution unit 600, MMU 602, cache unit 604, and/or BIU 606. The set of control registers 608 may include, for example, the multiple control registers of the x86 processor architecture.

Execution unit 600 of CPU 402C fetches instructions (e.g., x86 instructions) and data, executes the fetched instructions, and generates signals (e.g., address, data, and control signals) during instruction execution. Execution unit 600 is coupled to cache unit 604, and may receive instructions from memory 406 via cache unit 604 and BIU 606.

Memory 406 of computer system 400C includes multiple memory locations, each having a unique physical address. When operating in protected mode with paging enabled, an address space of CPU 402 is divided into multiple blocks called page frames or “pages.” Other memory units or divisions are also contemplated. As described above, only data corresponding to a portion of the pages is stored within memory 406 at any given time. In the embodiment of FIG. 6C, address signals generated by execution unit 600 during instruction execution represent segmented (i.e., “logical”) addresses. As described below, MMU 602 translates the segmented addresses generated by execution unit 600 to corresponding physical addresses of memory 406. MMU 602 provides the physical addresses to cache unit 604. Cache unit 604 is a relatively small storage unit used to store instructions and data recently fetched by execution unit 600. BIU 606 is coupled between cache unit 604 and host bridge 404, and is used to fetch instructions and data not present in cache unit 604 from memory 406 via host bridge 404.

FIG. 6D is a diagram of an alternate embodiment of the CPU 402 of the computer system 400. In the embodiment of FIG. 6D, the CPU 402D includes the execution unit 600, the MMU 602, the cache unit 604, the BIU 606, the set of control registers 608, and the set of secure execution mode (SEM) registers 610 described above with respect to FIG. 6A. In addition, the CPU 602D includes a microcode engine 650 and a microcode store 652, including security check code 654. The microcode engine 650 is coupled to the execution unit 600, the MMU 602, the cache unit 604, the BIU 606, the set of control registers 608, and the set of SEM registers 610. The coupling is shown as a shared bus structure, although other couplings are contemplated. The microcode engine 650 executes microcode instructions stored in the microcode store 652, and produces signals which control the operations of the execution unit 600, the MMU 602, the cache unit 604, and the BIU 606, dependent upon the microcode instructions, the contents of the set of control registers 608, and the contents of the set of SEM registers 610. In the embodiment of FIG. 6D, the microcode engine 650 executing the microcode instructions stored in the microcode store 652 may replace one or more of the CPU SCU 416 and the I/O SCU 417. In an x86 embodiment, the microcode engine 650 may also assist the execution unit 600 in executing more complex instructions of the x86 instruction set.

In the embodiment of FIG. 6D, a portion of the microcode instructions stored in the microcode store 652 form the security check code 654. The security check code 654 may be executed when the computer system 400 is operating in the SEM, and an instruction has been forwarded to the execution unit 600 for execution. In essence, the execution of the microcode instructions of the security check code 654 cause the microcode engine 650 and various ones of the execution unit 600, the MMU 602, and the BIU 606 to perform the functions of one or more of the CPU SCU 416 and the I/O SCU 417 described above.

For example, when an I/O instruction is forwarded to the execution unit 600 for execution, the execution unit 600 may signal the presence of the I/O instruction to the microcode engine 650. The microcode engine may assert signals to the MMU 602 and the BIU 606. In response to a signal from the microcode engine 650, the MMU 602 may provide the security context identification (SCID) value of the memory page including the I/O instruction to the BIU 606. The execution unit 600 may provide the I/O port number accessed by the I/O instruction to the BIU 606.

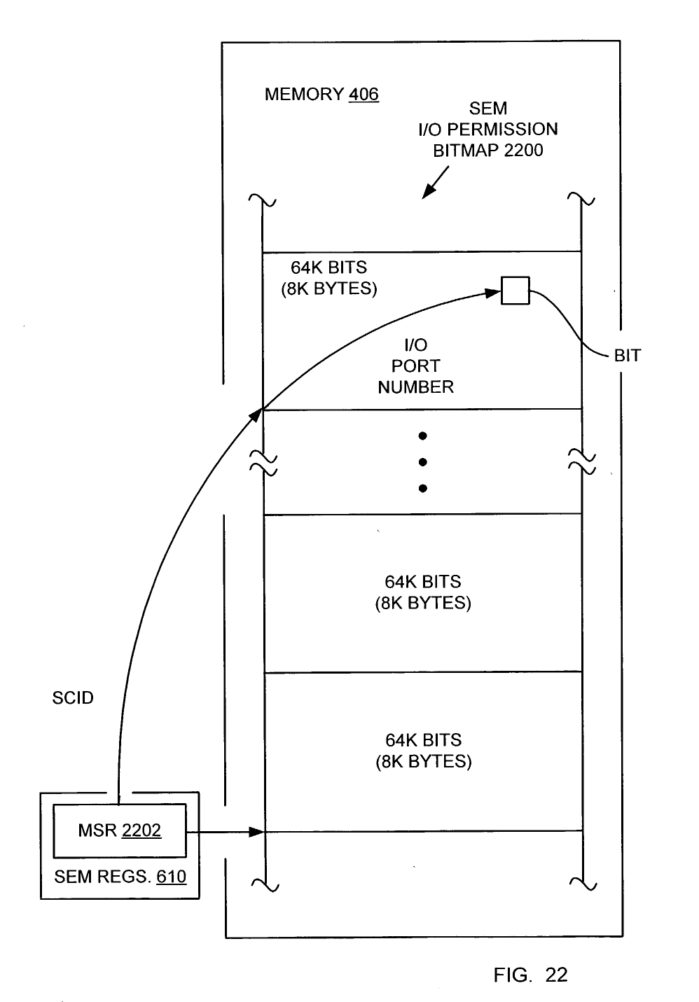

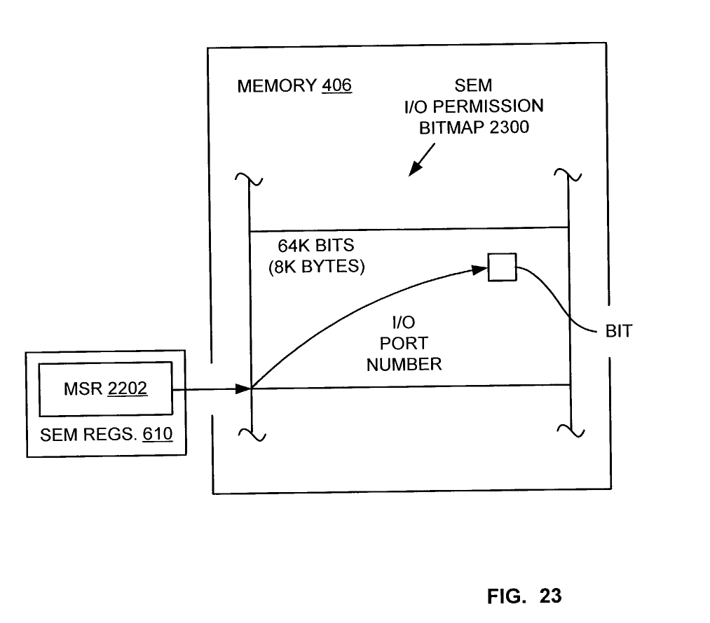

In response to a signal from the microcode engine 650, the BIU 606 may use the security context identification (SCID) value and the received I/O port number to access an SEM I/O permission bitmap 2200, 2300 (see FIGS. 22 and 23), and may provide the corresponding bit from the SEM I/O permission bitmap 2200, 2300 to the microcode engine 650. If the corresponding bit from the SEM I/O permission bitmap 2200, 2300 is cleared to ‘0’, the microcode engine 650 may continue to assist the execution unit 600 in completing the execution of the I/O instruction. If, on the other hand, the corresponding bit is set to ‘1’, the microcode engine 650 may signal the execution unit 600 to stop executing the I/O instruction and to start executing instruction of the SEM exception handler 1210.

Note also that the execution unit 600 may execute standard instructions, secure instructions, and/or microcode, depending on the implementation. Thus, in one embodiment, the execution unit 600 and the microcode engine 650 both execute microcode.

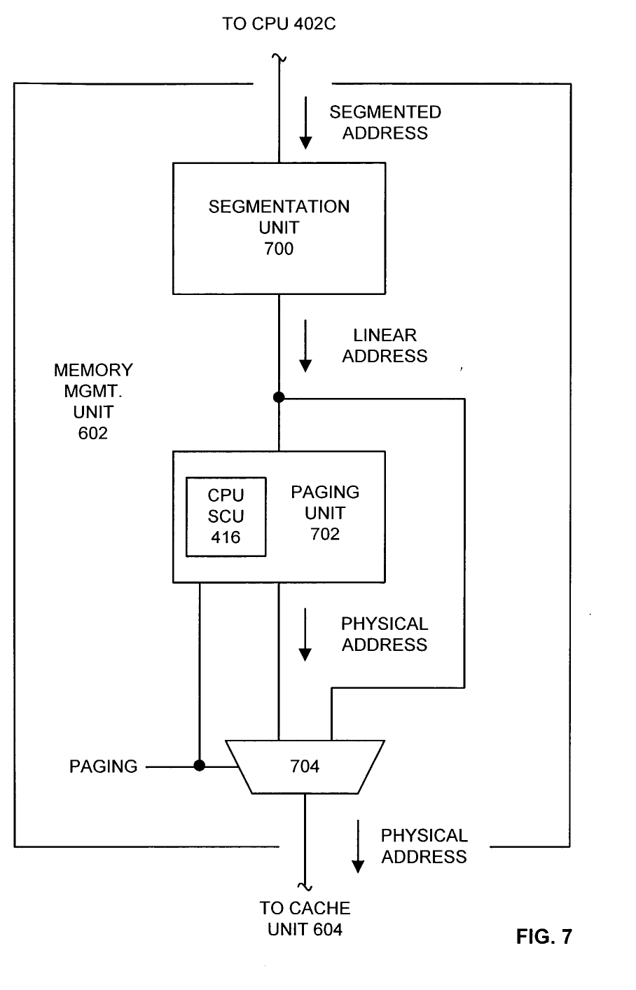

FIG. 7 is a diagram of one embodiment of MMU 602, such as shown in FIG. 6C, describing an x86 embodiment. In the embodiment of FIG. 7, MMU 602 includes a segmentation unit 700, a paging unit 702, and selection logic 704 for selecting between outputs of segmentation unit 700 and paging unit 702 to produce a physical address. As indicated in FIG. 7, segmentation unit 700 receives a segmented address from the execution unit 600 and may use a well-know segmented-to-linear address translation mechanism of the x86 processor architecture to produce a corresponding linear address at an output. As indicated in FIG. 7, when enabled by a “PAGING” signal, paging unit 702 receives the linear addresses produced by segmentation unit 700 and produces corresponding physical addresses at an output. The PAGING signal may mirror the paging flag (PG) bit in a control register 0 (CR0) of the x86 processor architecture and of the set of control registers 608. When the PAGING signal is deasserted, memory paging is not enabled, and selection logic 704 produces the linear address received from segmentation unit 700 as the physical address.

When the PAGING signal is asserted, memory paging is enabled, and paging unit 702 translates the linear address received from segmentation unit 700 to a corresponding physical address using the linear-to-physical address translation mechanism of the x86 processor architecture. During the linear-to-physical address translation operation, the contents of the U/S bits of the selected page directory entry and the selected page table entry are logically ANDed determine if the access to a page frame is authorized. Similarly, the contents of the R/W bits of the selected page directory entry and the selected page table entry are logically ANDed to determine if the access to the page frame is authorized. If the logical combinations of the U/S and R/W bits indicate the access to the page frame is authorized, paging unit 702 produces the physical address resulting from the linear-to-physical address translation operation. Selection logic 704 receives the physical address produced by paging unit 702, produces the physical address received from paging unit 702 as the physical address, and provides the physical address to cache unit 604.

On the other hand, if the logical combinations of the U/S and RIW bits indicate the access to the page frame is not authorized, paging unit 702 does not produce a physical address during the linear-to-physical address translation operation. Instead, paging unit 702 asserts a page fault (PF) signal, and MMU 602 forwards the PF signal to execution unit 600. In response to the PF signal, execution unit 600 may execute an exception handler routine, and may ultimately halt the execution of one of the application programs 500 running when the PF signal was asserted.

In the embodiment of FIG. 7, CPU SCU 416 is located within paging unit 702 of MMU 602. Paging unit 702 may also include a translation lookaside buffer (TLB) for storing a relatively small number of recently determined linear-to-physical address translations.

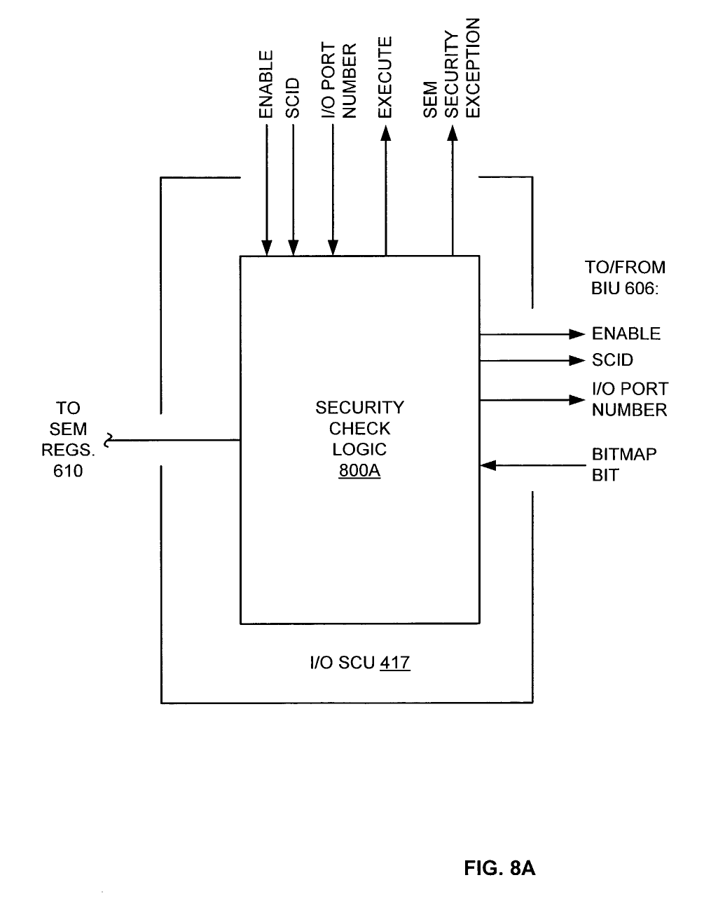

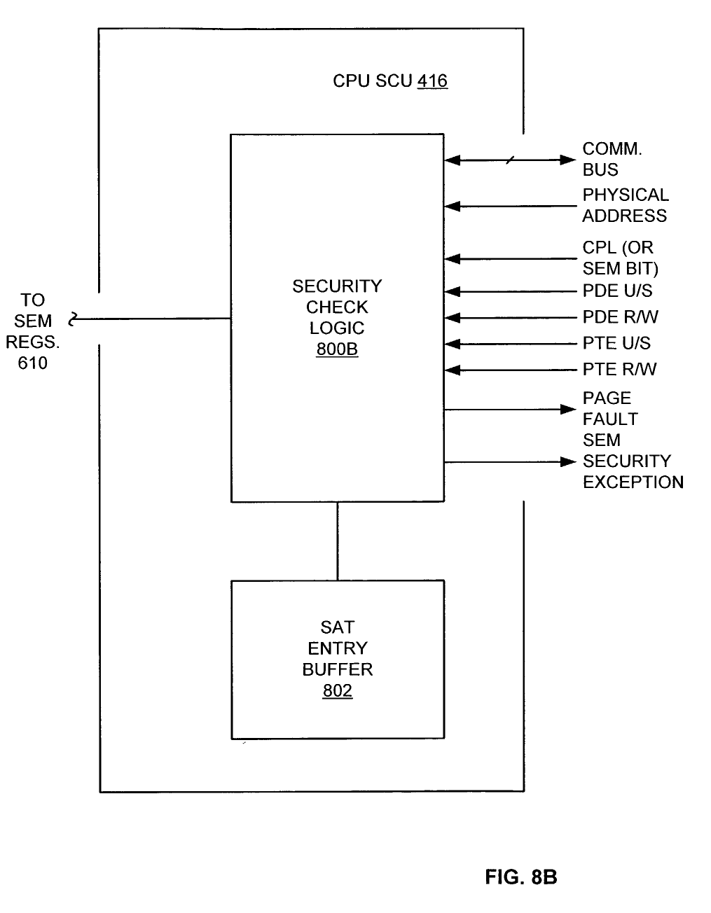

FIG. 8A is a diagram illustrating one embodiment of the I/O SCU 515 of FIG. 4. In the embodiment of FIG. 8A, the I/O SCU 417 includes security check logic 800A. The security check logic 800A receives an “ENABLE” signal and an I/O port number from the execution unit 400, and a SCID value from the MMU 602. The execution unit 600 may assert the ENABLE signal prior to executing an I/O instruction that accesses a “target” I/O port in the I/O address space. The I/O port number is the number of the target I/O port. The SCID value indicates a security context level of the memory page including the I/O instruction.

When the computer system operates in the SEM, the security kernel 504 generates and maintains one or more security attribute data structures (e.g., tables) in the memory 406. Each memory page has a corresponding SCID value, and the corresponding SCID value may be stored within the security attribute data structures. The MMU 602 uses an address generated during instruction execution (e.g., a physical address) to access the one or more security attribute data structures to obtain the SCIDs of corresponding memory pages. In general, the computer system 400 has n different SCID values, where n is an integer and n≧1.

When the computer system 400 operates in the SEM, the security kernel 504 may also generate and maintain an SEM I/O permission bitmap 2200, 2300 (e.g., FIGS. 22-23) in the memory 406. When the execution unit 600 executes an I/O instruction of a task, logic within the CPU 402B may first compare the CPL of the task to an I/O privilege level (IOPL). If the CPL of the task is at least as privileged as (i.e., is numerically less than or equal to) the IOPL, the logic within the CPU 402B may check the SEM I/O permission bitmap 2200, 2300. If, on the other hand, the CPL of the task is not as privileged as (i.e., is numerically greater than) the IOPL, then the execution unit 600 will not execute the I/O instruction. In one embodiment, a general protection fault (GPF) will occur.

When the execution unit 600 asserts the ENABLE signal, the security check logic 800A provides the ENABLE signal, the received SCID value, and the received I/O port number to logic within the BIU 406. The logic within the BIU 406 uses the SCID value and the received I/O port number to access the SEM I/O permission bitmap 2200, 2300, and provides the corresponding bit from the SEM I/O permission bitmap 2200, 2300 to the security check logic 800A. If the corresponding bit from the SEM I/O permission bitmap 2200, 2300 is cleared to ‘0’, the security check logic 800A may assert an output “EXECUTE” signal provided to the execution unit 600. In response to the asserted EXECUTE signals, the execution unit 600 may execute the I/O instruction. If, on the other hand, the corresponding bit is set to ‘1,’ the security check logic 800A may assert an output “SEM SECURITY EXCEPTION” signal provided to the execution unit 600. In response to the asserted SEM SECURITY EXCEPTION signal, the execution unit 600 may not execute the I/O instruction, and may instead execute an SEM exception handler (see below).

When the I/O instruction attempts to access a 16-bit word I/O port, or 32-bit double word I/O port, the execution unit 600 may provide the multiple byte I/O port numbers to the security check logic 800A in succession. If the security check logic 800A asserts the EXECUTE signal for each of the byte I/O port numbers, the execution unit 600 may execute the I/O instruction. If, on the other hand, the security check logic 800A asserts the SEM SECURITY EXCEPTION for one or more of the byte I/O port numbers, the execution unit 600 may not execute the I/O instruction, and may instead execute the SEM exception handler.

FIG. 8B is a diagram of one embodiment of the CPU SCU 416. In the embodiment of FIG. 8B, the CPU SCU 417 includes security check logic 800B coupled to the set of SEM registers 610 and a security attribute table (SAT) entry buffer 802. The SAT entries 1225 (see FIG. 12) may include additional security information above the U/S and R/W bits of page directory and page table entries corresponding to memory pages. Security check logic 800B uses the additional security information stored within a given one of the SAT entries 1225 to prevent unauthorized software-initiated accesses to the corresponding memory page. The SAT entry buffer 802 is used to store a relatively small number of SAT entries 1225 of recently accessed memory pages.

As described above, the set of SEM registers 610 may be used to implement the SEM within the computer system 400. The contents of the set of SEM registers 610 govern the operation of CPU SCU 417. Security check logic 800B receives information to be stored in SAT entry buffer 802 from MMU 602 via a communication bus indicated in FIG. 8B. The security check logic 800B also receives a physical address produced by a paging unit.

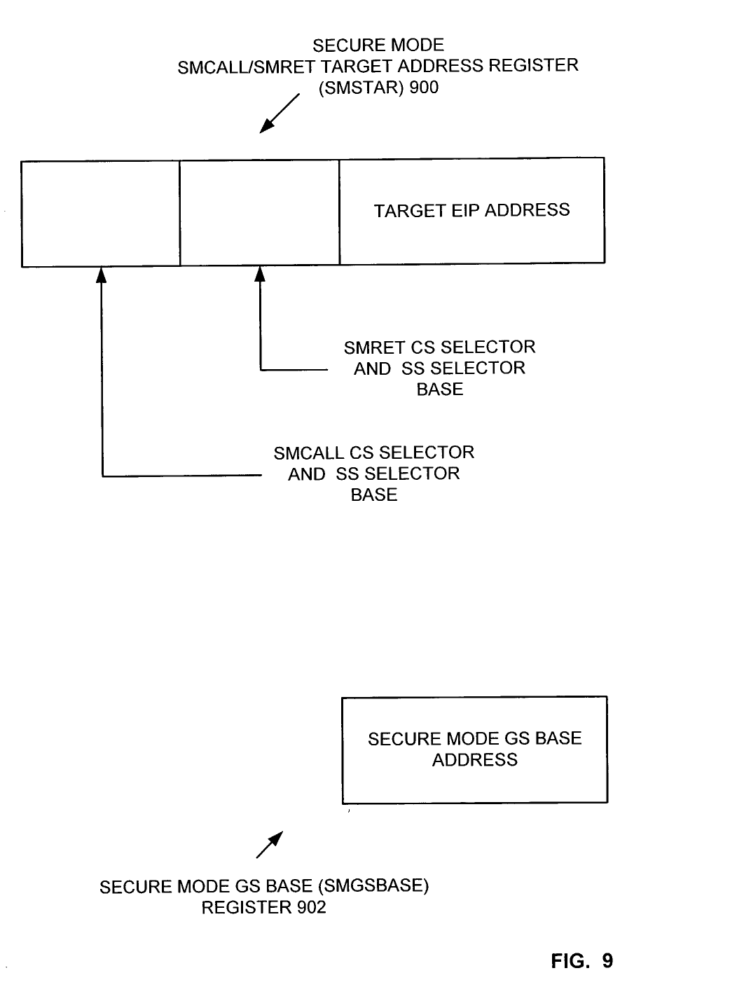

FIG. 9 is a diagram of a secure mode SMCALL/SMRET target address register (SMSTAR) 900 and a secure mode GS base (SMGSBASE) register 902 used to handle the SEM security exceptions.

For security reasons, the SEM security exception mechanism cannot rely on the contents of any load control registers or data structures to provide the addresses of the SEM exception handler and stack when the SEM security exception occurs.

The SMSTAR register 900 includes an “SMRET CS Selector and SS Selector Base” field, an “SMCALL CS Selector and SS Selector Base” field, and a “Target EIP Address” field. The SMGSBASE register 902 includes a secure mode GS base address. The values stored in the SMSTAR register 900 and the SMGSBASE register 902 are typically set at boot time.

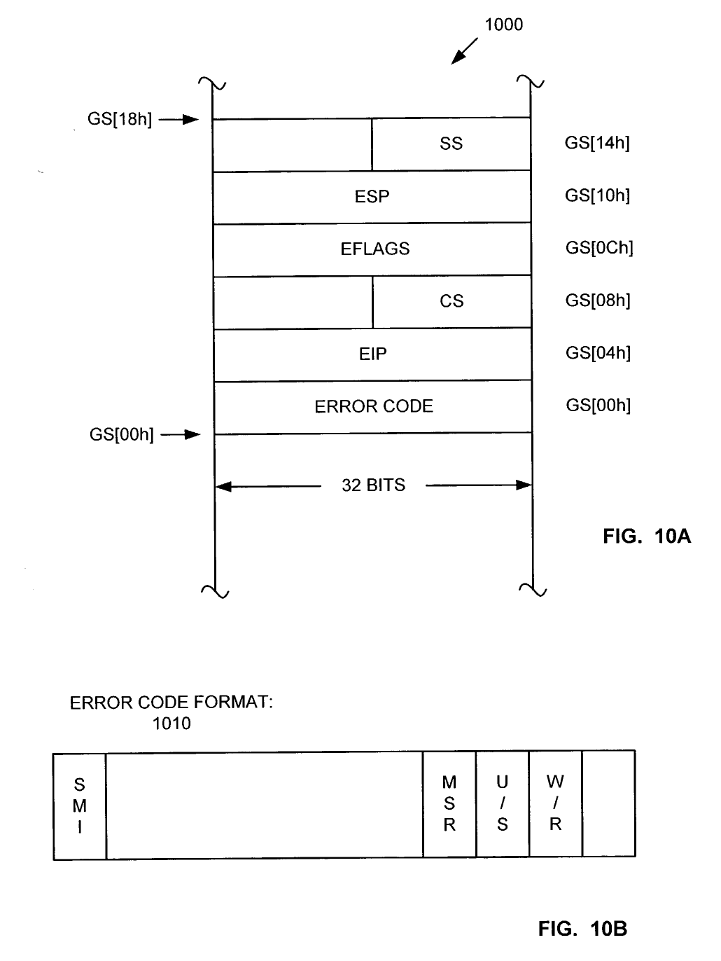

FIG. 10A is a diagram of one embodiment of an SEM exception stack frame 1000 generated by the operating system 502 when an SEM exception occurs. The SEM exception stack frame 1000 begins at GS[00 h].

An error code resides in the SEM exception stack frame 1000 at GS[00 h]. The contents of the instruction pointer (EIP) of the faulting application reside in the SEM exception stack frame 1000 at GS[04 h]. The contents of the code segment (CS) register of the faulting application reside in the SEM exception stack frame 1000 at GS[08 h]. The contents of the flags (EFLAGS) register of the faulting application reside in the SEM exception stack frame 1000 at GS[0 Ch]. The contents of the stack pointer (ESP) register of the faulting application reside in the SEM exception stack frame 1000 at GS[10 h]. The contents of the stack segment (SS) register of the faulting application reside in the SEM exception stack frame 1000 at GS[14 h].

FIG. 10B is a diagram of an exemplary format 1010 of the error code of the SEM exception stack frame 1000 of FIG. 10A. In the embodiment of FIG. 10B, the error code format includes a write/read (W/R) bit, a user/supervisor (U/S) bit, a model specific register (MSR) bit, and a system management interrupt (SMI) bit. The write/read (W/R) bit is ‘1’ when the SEM security exception occurred during a write operation, and is ‘0’ when the SEM security exception occurred during a read or execute operation. The user/supervisor (U/S) bit is ‘1’ when the secure execution mode (SEM) exception occurred in user mode (CPL=3), and is ‘0’ when the SEM security exception occurred in supervisor mode (CPL=0).

The model specific register (MSR) bit is ‘1’ when the SEM security exception occurred during an attempt to access a secure model specific register (MSR), and is ‘0’ when the SEM security exception did not occur during an attempt to access a secure MSR. The system management interrupt (SMI) bit is ‘1’ when the SEM security exception occurred during a system management interrupt (SMI), and is ‘0’ when the SEM security exception did not occur during an SMI.

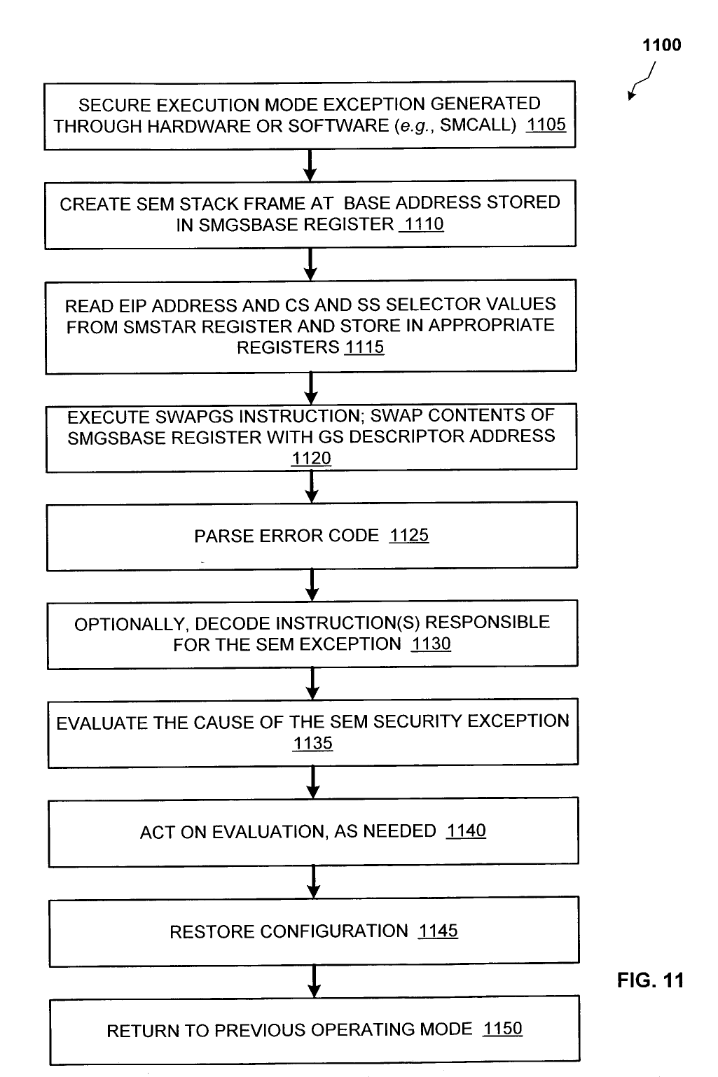

FIG. 11 illustrates a flowchart of an embodiment of a method 1100 of handling the SEM security exception, according to one aspect of the present invention. The method 1100 may include generating the SEM security exception, in block 1105, either through hardware or through software, such as through the SMCALL instruction. The method 1100 includes creating an SEM stack frame 1000 at a base address plus an offset, in block 1110. The secure mode GS base address is read from the SMGSBASE register 902. The SEM stack pointer may be formed from the secure mode GS base address offset by the number of bytes in the SEM stack frame. The SEM stack frame 1000 is written in memory such that the error code is at the location pointed to by the secure mode GS base address stored in the SMGSBASE register 902. The error code of the SEM security exception is generated by the SEM exception hardware. The SEM security exception itself may have be generated by the operating system 502, by device driver code 506, by application code 500, etc. The faulting code segment values are written into GS space as shown in FIG. 10A.

The method 1100 next reads the target EIP address and the SMCALL CS and SS selector values from the SMSTAR register 900 and stores the target EIP address and the SMCALL CS and SS selector values in the appropriate registers, in block 1115. The target EIP address is loaded into the EIP register. The CS selector value is loaded into the CS register, and the SS selector value is loaded into the SS register. The SS selector address may be derived from the CS selector address. The target EIP address points to the first instruction of the SEM security exception handler code.

The method 1100 also executes a SWAPGS instruction, in block 1120. The execution of the SWAPGS instruction swaps the contents of the SMGSBASE register 902 with the base address of the GS segment descriptor cached in the CPU 402. The subsequent SEM security exception handler instructions can access the SEM security exception stack frame 1000 and memory above or below the SEM security exception stack frame 1000 using GS space displacement-only addressing. The GS space addressing provides secure memory for the SEM security exception handler.

The SEM security exception handler in the security kernel 504 may include several pages of virtual memory protected by security bits, such as stored in the SEM registers 610, or other security measures described herein. The SEM security exception handler may include several pages of protected physical memory protected by security bits, such as stored in the SEM registers 610, or other security measures described herein.

The method 1100 next parses the error code, in block 1120. The error code bits may be parsed one at a time, as the source of the SEM security exception is determined. Optionally, the method 1100 decodes one or more instructions that were executed or prepared for execution before the SEM security exception was generated, in block 1130. The particular instructions and their operands may provide additional information on the source of the SEM security exception. The method 1100 evaluates the SEM security exception, in block 1135, based on the error code and, possibly, the instructions prior to or after the instruction that caused the generation of the SEM security exception. The evaluation of the block 1135 may include referencing a look-up table or performing a security algorithm. The look-up table may be indexed by one or more of the error code, one or more bits of the error code, and one or more of the particular instructions and/or their operands. The security algorithm may include a code tree performed by the security kernel 504. Both the look-up table and the security algorithm will determine on the exact hardware 310, etc. and operating system 402 implemented in the computer system 300.

Once the method 1100 evaluates the SEM security exception, in block 1135, the method 1100 acts on that evaluation, as needed, in block 1140. The SEM security exception may be ignored and operations resumed. The faulting instruction or code segment may be ignored. The faulting instruction or code segment may be contained so that the faulting instruction or code segment is executed by proxy, in a virtual memory or I/O space.

The method 1100 mostly restores the computer system 300 to its pre-SEM security exception configuration, in block 1145. When the SEM security exception handler exits, another SWAPGS instruction is executed to return the secure mode base address value to its original value and an SMRET instruction is executed to return to the previous operating mode, in block 1150. When executing the SWAPGS instruction, the security kernel 504 writes values for the code segment (CS) of the faulting code to the SMRET CS Selector and SS Selector Base field of the SMSTAR register 900. The SMRET instruction may return the system 300 to normal mode. Unlike the SYSRET instruction, the SMRET instruction may leave the CPL at 0, and does not set the EFLAGS.IF bit.

Note that in one embodiment, blocks 1105-1115 of the method 1100 are carried out primarily in hardware, while blocks 1120-1145 are carried out primarily in software. In another embodiment, the method 1100 is carried out primarily in software. In yet another embodiment, the method 1100 is carried out primarily in hardware. Note that in one embodiment, the EIP address is modified to avoid an instruction that may have caused the SEM security exception.

Referring back to FIG. 8B, when computer system 300 is operating in the SEM, security check logic 800B receives the CPL of the currently executing task (i.e., the currently executing instruction), along with normal control bits and one or more SEM bits 509 associated with a selected memory page within which a physical address resides. Security check logic 800B uses the above information to determine if access to that portion of the memory 406 is authorized.

The CPU 402 may be an x86 processor, and may include a code segment (CS) register, one of the 16-bit segment registers of the x86 processor architecture. Each segment register selects a 64 k block of memory, called a segment. In the protected mode with paging enabled, the CS register is loaded with a segment selector that indicates an executable segment of memory 406. The highest ordered (i.e., most significant) bits of the segment selector are used to store information indicating a segment of memory including a next instruction to be executed by the execution unit 600 of the CPU 402. An instruction pointer (IP) register is used to store an offset into the segment indicated by the CS register. The CS:IP pair indicate a segmented address of the next instruction. The two lowest ordered (i.e., least significant) bits of the CS register are used to store a value indicating the CPL of the task currently being executed by the execution unit 600 (i.e., the CPL of the current task).

The security check logic 800B of the CPU SCU 416 may produce a page fault (“PF”) signal and as “SEM SECURITY EXCEPTION” signal, and provide the PF and the SEM SECURITY EXCEPTION signals to logic within the paging unit 702. When the security check logic 800B asserts the PF signal, the MMU 602 forwards the PF signal to the execution unit 600. In response to the PF signal, execution unit 600 may use the well-known interrupt descriptor table (IDT) vectoring mechanism of the x86 processor architecture to access and execute a PF handler routine.

When the security check logic 800B asserts the SEM SECURITY EXCEPTION signal, the MMU 602 forwards the SEM SECURITY EXCEPTION signal to the execution unit 600. Unlike normal processor exceptions that use the IDT vectoring mechanism of the x86 processor architecture, a different vectoring method may be used to handle SEM security exceptions. The SEM security exceptions may be dispatched through a pair of registers (e.g., MSRs) similar to the way x86 “SYSENTER” and “SYSEXIT” instructions operate. The pair of registers may be “security exception entry point” registers, and may define a branch target address for instruction execution when the SEM security exception occurs.

The security exception entry point registers may define the code segment (CS), then instruction pointer (EIP, or the 64-bit version RIP), stack segment (SS), and the stack pointer (ESP, or the 64-bit version RSP) values to be used on entry to a SEM security exception handler. The execution unit 600 may push the previous SS, ESP/RSP, EFLAGS, CS, and EIP/RIP values onto a new stack to indicate where the SEM security exception occurred. In addition, the execution unit 600 may push an error code onto the stack. As noted above, the IRET instruction may not be used as the previous SS and ESP/RSP values are saved, and a stack switch is accomplished, even if a change in CPL does not occur. The return from the SEM security exception handler is via the SMRET instruction.

FIG. 12 shows a diagram 1200 incorporating various embodiments for maintaining security in the computer system, according to various aspects of the present invention. As shown in FIG. 12, the operating system may include the security kernel 504. The security kernel 504 may include an SEM security exception handler 1210 and/or a page management routine 1215. The security kernel 504 receives the SEM security exception 1205. The security kernel 504 receives one or more values that convey a current CPU state 1230 through one or more signals 1255. The security kernel 504 may also modify the current CPU state 1230 through the one or more signals 1255. The CPU state 1230 may be determined from the values stored in control registers 1235 and MSRs 1240. The values may include those stored in the CR3 control register 1242, the CPL 1244, and the SEM enable bit 1246.

Other values are contemplated as included, for example, CR0 to turn paging on and off, the extended features register, or the page address extension mode register for extended addressing, etc. One or more of the illustrated values 1242, 1244, 1246 may also be excluded, as desired. The security kernel 504 receives security values and signals 1250 from one or more of the CPU state 1230, a virtual memory configuration 1220, and security attribute entries 1225. The security values 1250A is shown between the security kernel 504 and the virtual memory configuration 1220. The security values 1250B is shown between the security kernel 504 and the security attribute entries 1225. The security values 1250C is shown between the security kernel 504 and the CPU state 1230.

In one embodiment, the virtual memory configuration 1220 is monitored through 1250A by the security kernel 504 through the page management routine 1215 to maintain security for accesses to the memory 406. The CPU state 1230 is also monitored by the security kernel 504 so that the proper security is applied by the page management routine 1215. The virtual memory configuration 1220 may also be modified by the page management routine 1215 through 1250A. The page management routine 1215 may be a part of the operating system 502. The page management routine 1215 may also use the SEM security exception handler 1210 to supervise changes to the virtual memory configuration 1220.

In one embodiment, the security attribute entries 1225 are monitored through 1250B by the security kernel 504. An attempted access to a memory location may generate an SEM security exception 1205 to the SEM security exception handler 1210 and lead to a change in the CPU state 1230 to the SEM. Access to the memory location may be allowed or denied according to an associated one of the security attribute entries 1225. The security attribute entries 1225 may be in a protected page in the memory 406.

In one embodiment, the CPU state 1230 is monitored through 1250C by the security kernel 504. This embodiment is modal. An attempted access to a memory location may generate an SEM security exception 1205 to the SEM security exception handler 1210. Access to the memory location may be allowed or denied according to the CPU state 1230 at the time of the attempted access.

Contents of general purpose registers (not shown) within the CPU 402 are available at any given time. In one embodiment, access to the control registers 1235 is tied to a value of a security bit, e.g., a TX (trusted execution) bit in the control registers 1235 or an SIE (secure instruction) bit in the MSRs 1240. Similarly, access to the MSRs 1240 may also be tied to a value of a security bit. If the security bit is not set, then any attempted changes to security sensitive control registers 1235 and MSRs 1240 results in a SEM security exception 1205. In another embodiment, an execution page value may control access to the control registers 1235.

The transition from secure mode, e.g., SEM, into an insecure mode, e.g., normal mode, clears the contents of certain registers. The memory contents remain static, but certain memory addresses can no longer be read. When using the virtual memory configuration 1220 to enforce security, the contents of the CR3 register 1242 may be reloaded. This provides a virtual memory configuration 1220 to untrusted code different from the virtual memory configuration 1220 used by trusted code. When using the security attribute entries 1225, the entries associated with secure pages may be marked as protected in the page tables, preventing access unless the CPU state 1230 is in a secure (or protected) mode. When using the CPU state 1230 to enforce security, the CPU state 1230 must be in a secure mode before access to protected memory is granted.

In one embodiment, the security kernel 504 in the SEM may provide protection over the virtual memory configuration 1220 by implementing the page management routine 1215. This protection requires minimal hardware and is implemented primarily in software that executes at the highest privilege (SCID) level.

The SEM is applicable to protected mode environments with paging enabled. To prevent attacks against the SEM by creating improper or scrambled linear to physical mapping, it is necessary to protect the paging structures and the control registers 1235 and/or the MSRs 1240 associated with paging, such as CR3 1242, from improper modification.

Note that security enforced using one of the mechanisms described in FIG. 12, the virtual memory configuration 1220, the security attribute entries 1225, and the CPU state 1230, may be exclusive of the remaining mechanisms. In other embodiments, two or more of these mechanisms may work cooperatively.

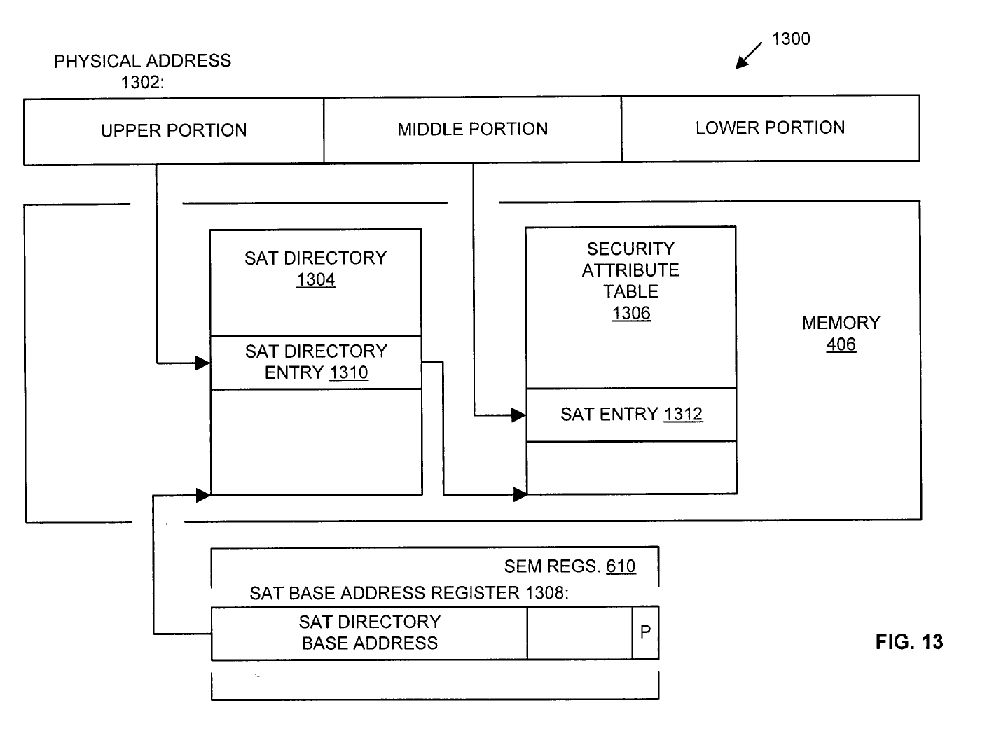

FIGS. 13-15 will now be used to describe how additional security information of memory pages selected using an address translation mechanism that may be used within computer systems 400 of FIGS. 4A-4C. FIG. 13 is a diagram of one embodiment of a mechanism 1300 for accessing an associated one of the SAT entries 1225 for a selected memory page in order to obtain additional security information of the selected memory page. Mechanism 1300 of FIG. 13 may be embodied within security check logic 800 of FIGS. 8A-8B, and may be implemented when any of computer systems 400 of FIGS. 4A-4C is operating in the SEM. Mechanism 1300 involves a physical address 1302 produced by paging mechanism 702 using the x86 address translation mechanism, a SAT directory 1304, multiple SATs including a SAT 1306, and a SAT base address register 1308 of the set of SEM registers 610. SAT directory 104 and the multiple SATs, including SAT 1306, are SEM data structures created and maintained by the security kernel 504. As described below, the SAT directory 1304 (when present) and any needed SAT 1306 are copied into the memory 406 before being accessed.

The SAT base address register 1308 includes a present (P) bit which indicates the presence of a valid SAT directory base address within SAT base address register 1308. The highest ordered (i.e., most significant) bits of SAT base address register 1308 are reserved for the SAT directory base address. The SAT directory base address is a base address of a memory page containing SAT directory 1304. If P=1, the SAT directory base address is valid, and SAT tables 1306 specify the security attributes of memory pages. If P=0, the SAT directory base address is not valid, no SAT tables exist, and security attributes of memory pages are determined by a SAT default register.

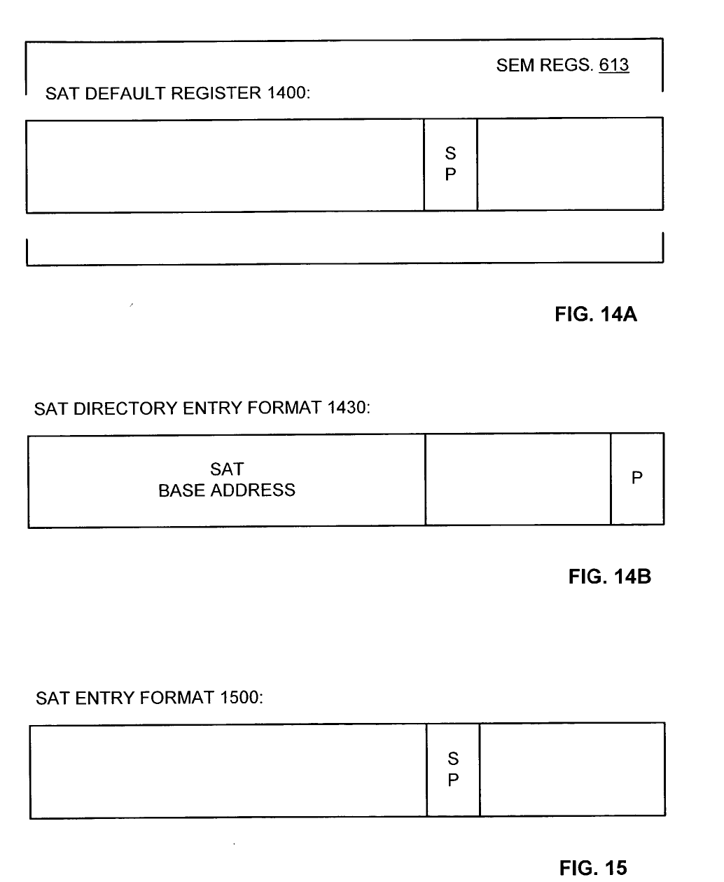

FIG. 14A is a diagram of one embodiment of the SAT default register 1400. In the embodiment of FIG. 14A, the SAT default register 1400 includes a secure page (SP) bit. The SP bit indicates whether or not all memory pages are secure pages. For example, if SP=0 all memory pages may not be secure pages, and if SP=1 all memory pages may be secure pages.

Referring back to FIG. 13 and assuming the P bit of the SAT base address register 1308 is a ‘1’, the physical address 1302 produced by the paging logic 702 is divided into three portions in order to access the associated one of the SAT entries 1225 for the selected memory page. As described above, the SAT directory base address of SAT base address register 1308 is the base address of the memory page containing SAT directory 1304. The SAT directory 1304 includes multiple SAT directory entries, including a SAT directory entry 1312. Each SAT directory entry may have a corresponding SAT in memory 406. An “upper” portion of physical address 1302, including the highest ordered or most significant bits of physical address 1302, is used as an index into SAT directory 1304. The SAT directory entry 1312 is selected from within SAT directory 304 using the SAT directory base address of SAT base address register 1308 and the upper portion of physical address 1302.

FIG. 14B is a diagram of one embodiment of a SAT directory entry format 1430. In accordance with FIG. 14B, each SAT directory entry includes a present (P) bit which indicates the presence of a valid SAT base address within the SAT directory entry. In the embodiment of FIG. 14B, the highest ordered (i.e., the most significant) bits of each SAT directory entry 1310 are reserved for a SAT base address. The SAT base address is a base address of a memory page containing a corresponding SAT. If P=1, the SAT base address is valid, and the corresponding SAT is stored in memory 406.

If P=0, the SAT base address is not valid, and the corresponding SAT does not exist in memory 406 and must be copied into memory 406 from a storage device (e.g., a disk drive). If P=0, security check logic 800 may signal a page fault to logic within paging unit 702, and MMU 602 may forward the page fault signal to execution unit 600 (FIG. 6). In response to the page fault signal, execution unit 600 may execute a page fault handler routine which retrieves the needed SAT from the storage device and stores the needed SAT in memory 406. After the needed SAT is stored in memory 406, the P bit of the corresponding SAT directory entry is set to ‘1’, and mechanism 1300 is continued.

Referring back to FIG. 13, a “middle” portion of physical address 1302 is used as an index into SAT 1306. SAT entry 1312 is thus selected within SAT 1306 using the SAT base address of SAT directory entry 1312 and the middle portion of physical address 1302.

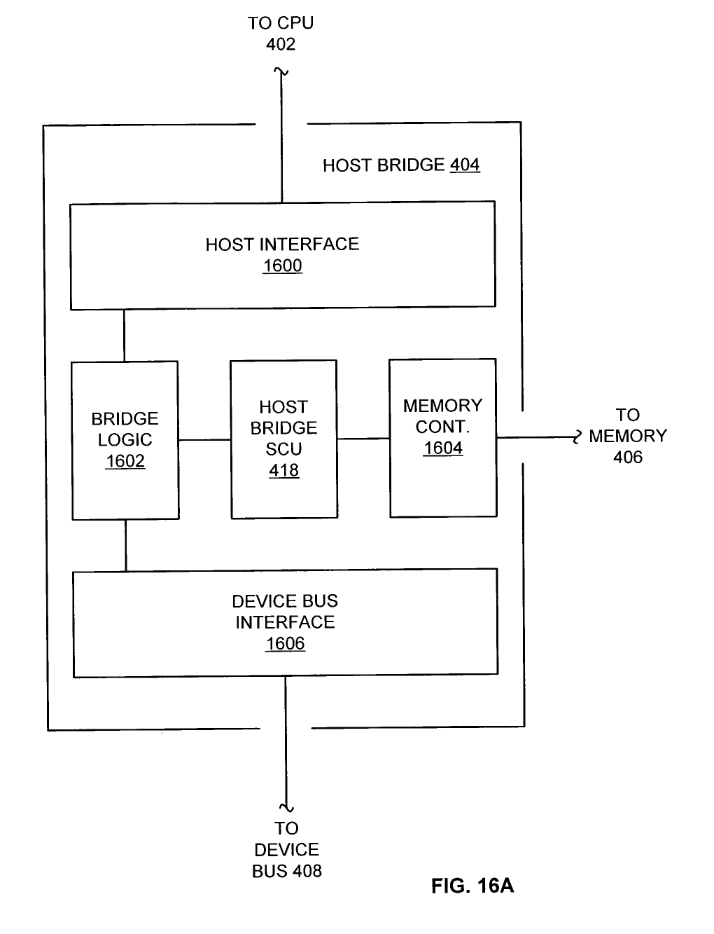

FIG. 15 is a diagram of one embodiment of a SAT entry format 1500. In the embodiment of FIG. 15, each SAT entry 1312 includes a secure page (SP) bit. The SP bit indicates whether or not the selected memory page is a secure page. For example, if SP=0 the selected memory page may not be a secure page, and if SP=1 the selected memory page may be a secure page.

The BIU 606 retrieves needed SEM data structure entries from memory 406, and provides the SEM data structure entries to MMU 602. Referring back to FIG. 8B, security check logic 800B receives SEM data structure entries from the MMU 602 and the paging unit 702 via the communication bus. As described above, SAT entry buffer 802 is used to store a relatively small number of SAT entries 1225 of recently accessed memory pages. The security check logic 800B stores a given SAT entry 1312 in the SAT entry buffer 802, along with a “tag” portion of the corresponding physical address.

During a subsequent memory page access, security check logic 800B may compare a “tag” portion of a physical address produced by paging unit 702 to tag portions of physical addresses corresponding to SAT entries 1225 stored in the SAT entry buffer 1102. If the tag portion of the physical address matches a tag portion of a physical address corresponding to a SAT entry 1312 stored in the SAT entry buffer 1102, the security check logic 800B may access the SAT entry 1312 in the SAT entry buffer 1102, eliminating the need to perform the process of FIG. 13 to obtain the SAT entry 1312 from memory 406. Security kernel 504 modifies the contents of SAT base address register 1308 in the CPU 402 (e.g., during context switches). In response to modifications of SAT base address register 1308, the security check logic 800B of CPU SCU 417 may flush the SAT entry buffer 802.

When computer system 400 of FIGS. 4A-4C are operating in the SEM, security check logic 800B receives the CPL of the currently executing task (i.e., the currently executing instruction), along with the page directory entry (PDE) U/S bit, the PDE R/W bit, the page table entry (PTE) U/S bit, and the PTE R/W bit of a selected memory page within which a physical address resides. The security check logic 800B uses the above information, along with the SP bit of the SAT entry 1312 corresponding to the selected memory page, to determine if memory 406 access is authorized.

The CPU 402B of FIG. 4B may be an x86 processor, and may include a code segment (CS) register, one of the 16-bit segment registers of the x86 processor architecture. Each segment register selects a 64 k block of memory, called a segment. In the protected mode with paging enabled, the CS register is loaded with a segment selector that indicates an executable segment of memory 406. The highest ordered (i.e., most significant) bits of the segment selector are used to store information indicating a segment of memory including a next instruction to be executed by execution unit 600 of CPU 402B. An instruction pointer (IP) register is used to store an offset into the segment indicated by the CS register. The CS:IP pair indicate a segmented address of the next instruction. The two lowest ordered (i.e., least significant) bits of the CS register are used to store a value indicating the CPL of a task currently being executed by execution unit 600 (i.e., the CPL of the current task).

Table 1 below illustrates exemplary rules for CPU-initiated (i.e., software-initiated) memory accesses when computer system 400B is operating in the SEM. The CPU SCU 417 and the security kernel 504 work together to implement the rules of Table 1 when the computer system 400 is operating in the SEM to provide additional security for data stored in the memory 406 above data security provided by the operating system 502.

TABLE 1
Exemplary Rules For Software-Initiated Memory Accesses
When Computer System 400B Is Operating In The SEM.

| Currently | | Selected | | | | |
|---|---|---|---|---|---|---|
| Executing | | Memory | | | | |
| Instruction | | Page | | | Permitted | |
| SP | CPL | SP | U/S | R/W | Access | Remarks |
| 1 | 0 | X | X | 1(R/W) | R/W | Full access granted. (1) |
| 1 | 0 | X | X | 0(R) | Read | (2) |
| 1 | 3 | 1 | 1(U) | 1(R/W) | Standard protection | |
| | | | | | mechanisms apply. | |
| 1 | 3 | 1 | 0(S) | X | None | Access causes GPF. (1) |
| 1 | 3 | 0 | 0 | 1 | None | Access causes GPF. (4) |
| 0 | 0 | 1 | X | X | None | Access causes SEM |
| | | | | | | security exception. |
| 0 | 0 | 0 | 1 | 1 | R/W | Standard protection |
| | | | | | | mechanisms apply. (3) |
| 0 | 3 | X | 0 | X | None | (Note 5) |
| 0 | 3 | 0 | 1 | 1 | R/W | Standard protection |
| | | | | | | mechanisms apply. (6) |

Note (1): Typical accessed page contents include security kernel and SEM data structures.
Note (2): Write attempt causes GPF; if the selected memory page is a secure page (SP = 1), a SEM Security Exception is signaled instead of GPF.
Note (3): Typical accessed page contents include high security applets.
Note (4): Typical accessed page contents include OS kernel and Ring 0 device drivers.
Note (5): Any access attempt causes GPF; if the selected memory page is a secure page (SP = 1), a SEM Security Exception is signaled instead of GPF.
Note (6): Typical accessed page contents include applications.

In Table 1 above, the SP bit of the currently executing instruction is the SP bit of the SAT entry 1312 corresponding to the memory page containing the currently executing instruction. The U/S bit of the selected memory page is the logical AND of the PDE U/S bit and the PTE U/S bit of the selected memory page. The R/W bit of the selected memory page is the logical AND of the PDE R/W bit and the PTE R/W bit of the selected memory page. The symbol “X” signifies a “don't care”: the logical value may be either a ‘0’ or a ‘1’.

Referring back to FIG. 8B, security check logic 800B of CPU SCU 417 produces a general protection fault (“GPF”) signal and a “SEM SECURITY EXCEPTION” signal, and provides the GPF and the SEM SECURITY EXCEPTION signals to logic within paging unit 702. When security check logic 800B asserts the GPF signal, MMU 602 forwards the GPF signal to execution unit 600. In response to the GPF signal, execution unit 600 may use the well-known interrupt descriptor table (IDT) vectoring mechanism of the x86 processor architecture to access and execute a GPF handler routine.

When security check logic 800B asserts the SEM SECURITY EXCEPTION signal, MMU 602 forwards the SEM SECURITY EXCEPTION signal to execution unit 600. Unlike normal processor exceptions that use the IDT vectoring mechanism of the x86 processor architecture, a different vectoring method may be used to handle SEM security exceptions. SEM security exceptions may be dispatched through a pair of registers (e.g., MSRs) similar to the way x86 “SYSENTER” and “SYSEXIT” instructions operate. The pair of registers may be “security exception entry point” registers, and may define a branch target address for instruction execution when a SEM security exception occurs. The security exception entry point registers may define the code segment (CS), then instruction pointer (IP, or the 64-bit version RIP), stack segment (SS), and the stack pointer (SP, or the 64-bit version RSP) values to be used on entry to a SEM security exception handler 1210. Under software control, execution unit 600 may push the previous SS, SP/RSP, EFLAGS, CS, and IP/RIP values onto a new stack to indicate where the exception occurred. In addition, execution unit 600 may push an error code onto the stack. As noted above, the IRET instruction may not be used as the previous SS and SP/RSP values are always saved, and a stack switch is always accomplished, even if a change in CPL does not occur. The return from the SEM security exception handler 1210 is via the SMRET instruction.

Table 2 below illustrates exemplary rules for memory page accesses initiated by device hardware units 414A-414D (i.e., hardware-initiated memory accesses) when computer system 400 is operating in the SEM. Such hardware-initiated memory accesses may be initiated by bus mastering circuitry within device hardware units 414A-414D, or by DMA devices at the request of device hardware units 414A-414D. The security check logic 800 may implement the rules of Table 2 when computer system 400 is operating in the SEM in order to provide additional security for data stored in memory 406 above data security provided by operating system 502. In Table 2 below, the “target” memory page is the memory page within which a physical address conveyed by memory access signals of a memory access resides.

TABLE 2
Exemplary Rules For Hardware-Initiated Memory Accesses
When Computer system 400 is Operating in the SEM.

| Particular | | |
|---|---|---|
| Memory | | |
| Page | Access | |
| SP | Type | Action |
| 0 | R/W | The access completes as normal. |
| 1 | Read | The access is completed returning all “F”s |
| | | instead of actual memory contents. The |
| | | unauthorized access may be logged. |
| 1 | Write | The access is completed but write data are |
| | | discarded. Memory contents remain unchanged. |
| | | The unauthorized access may be logged. |

In Table 2 above, the SP bit of the target memory page is obtained by host bridge SCU 418 using the physical address of the memory access and the above described mechanism 900 of FIG. 9 for obtaining SAT entries 1225 of corresponding memory pages.

As indicated in Table 2, when SP=1 indicating the target memory page is a secure page, the memory access is unauthorized. In this situation, security check logic 800 does not provide the memory access signals to the memory controller. A portion of the memory access signals (e.g., the control signals) indicate a memory access type, and wherein the memory access type is either a read access or a write access. When SP=1 and the memory access signals indicate the memory access type is a read access, the memory access is an unauthorized read access, and security check logic 800 responds to the unauthorized read access by providing all “F”s instead of actual memory contents (i.e., bogus read data). Security check logic 800 may also respond to the unauthorized read access by logging the unauthorized read access as described above.

When SP=1 and the memory access signals indicate the memory access type is a write access, the memory access is an unauthorized write access. In this situation, security check logic 800 responds to the unauthorized write access by discarding write data conveyed by the memory access signals. Security check logic 800 may also respond to the unauthorized write access by logging the unauthorized write access as described above.

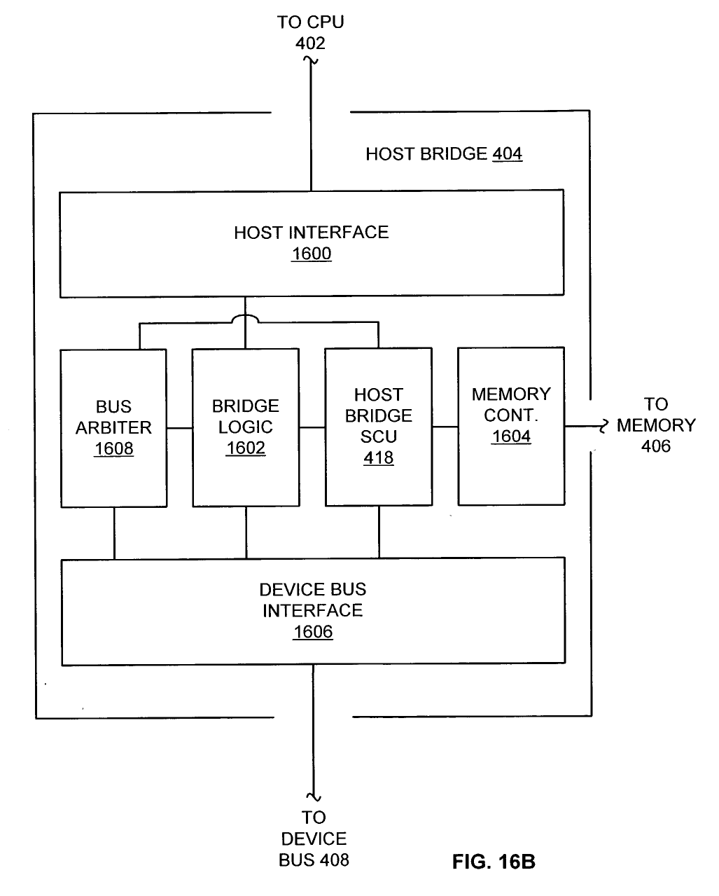

FIG. 16A is a diagram of one embodiment of host bridge 404C of FIG. 4C. In the embodiment of FIG. 16A, host bridge 404C includes a host interface 1600, bridge logic 1602, the host bridge SCU 418, a memory controller 1604, and a device bus interface 1606. Host interface 1600 is coupled to CPU 402, and device bus interface 1606 is coupled to device bus 408. Bridge logic 1602 is coupled between host interface 1600 and device bus interface 1606. Memory controller 1604 is coupled to memory 406, and performs all accesses to memory 406. The host bridge SCU 418 is coupled between the bridge logic 1602 and the memory controller 1604. As described above, the host bridge SCU 418 controls access to the memory 406 via the device bus interface 1606. The host bridge SCU 418 monitors all accesses to the memory 406 via the device bus interface 1606, and allows only authorized accesses to the memory 406.

FIG. 16B is a diagram of another embodiment of host bridge 404C of FIG. 4C. In the embodiment of FIG. 16C, the host bridge 404C includes a host interface 1600, bridge logic 1602, host bridge SCU 418, a memory controller 1604, a device bus interface 1606, and a bus arbiter 1608. The host interface 1600 is coupled to the CPU 402, and the device bus interface 1606 is coupled to the device bus 408. The bridge logic 1602 is coupled between the host interface 1600 and the device bus interface 1606. The memory controller 1604 is coupled to the memory 406, and performs all accesses to the memory 406. The host bridge SCU 418 is coupled between the bridge logic 1602 and the memory controller 1604. As described above, host bridge SCU 418 controls access to memory 406 via device bus interface 1606. The host bridge SCU 418 monitors all accesses to the memory 406 via the device bus interface 1606, and allows only authorized accesses to the memory 406.

In the embodiment of FIG. 16B, bus arbiter 1608 is coupled to device bus interface 1606, bridge logic 1602, and the host bridge SCU 418. Bus arbiter 1608 arbitrates between bridge logic 1602, device hardware units 414A and 414B, and device bus bridge 410 for control of device bus 408. (Device hardware units 414C and 414D access device bus 408 via device bus bridge 410.) In general, device bus 408 may include one or more signal lines conveying a grant signal, wherein the grant signal is in one of multiple states indicating which of the devices coupled to device bus 408 has control of device bus 408. Bus arbiter 1608 may drive the grant signal upon the one or more-signal lines conveying the grant signal. Bus arbiter 1608 may, as is typical, receive separate request signals from device hardware units 414A and 414B and device bus bridge 410, wherein each request signal is asserted by the corresponding device when the corresponding device needs to control device bus 408. Bus arbiter 1608 may issue separate grant signals to the device hardware units 414A and 414B and to device bus bridge 410, wherein a given one of the grant signals is asserted to indicate the corresponding device is granted control of device bus 408. The bus arbiter 1608 may work with the host bridge SCU 418 to provide device-to-device access security within computer system 400C.

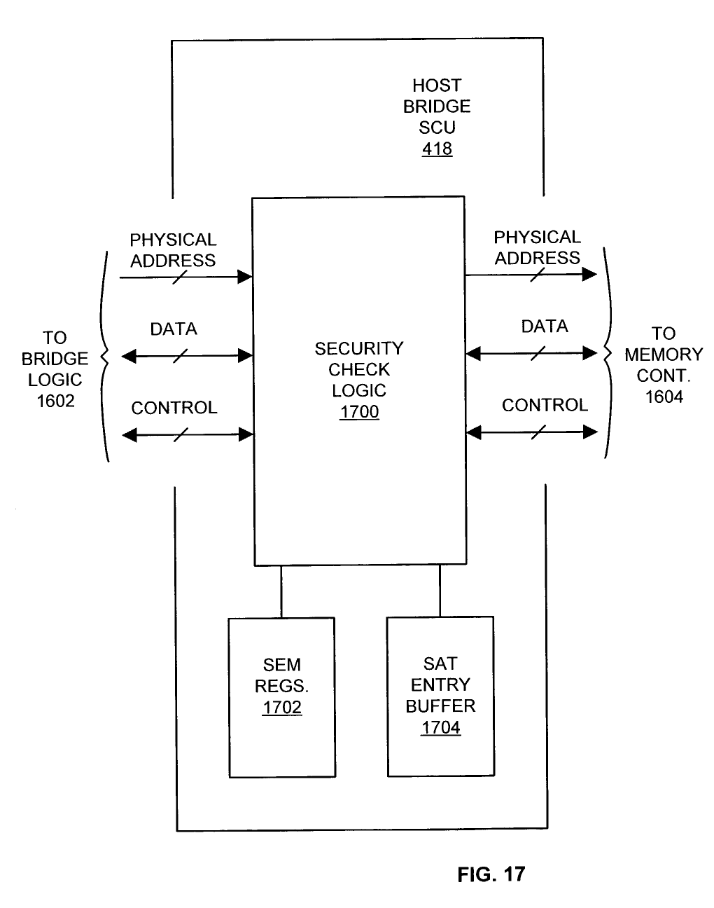

FIG. 17 is a diagram of one embodiment of host bridge SCU 418 of FIGS. 16A or 16B. In the embodiment of FIG. 17, host bridge SCU 418 includes security check logic 1700 coupled to a set of SEM registers 1702 and a SAT entry buffer 1704. The set of SEM registers 1702 govern the operation of security check logic 1700, and includes a second SAT base address register 908 of FIG. 9. The second SAT base address register 908 of the set of SEM registers 1702 may be an addressable register. When security kernel 504 modifies the contents of SAT base address register 908 in the set of SEM registers 610 of CPU 402 (e.g., during a context switch), security kernel 504 may also write the same value to the second SAT base address register 908 in the set of SEM registers 1702 of host bridge SCU 418. In response to modifications of the second SAT base address register 908, security check logic 1700 of host bridge SCU 418 may flush SAT entry buffer 1704.

Security check logic 1700 receives memory access signals of memory accesses initiated by hardware device units 417A-417D via device bus interface 1606 and bridge logic 1602. The memory access signals convey physical addresses from hardware device units 417A-417D, and associated control and/or data signals. Security check logic 1700 may embody mechanism 1300 for obtaining SAT entries 1225 of corresponding memory pages, and may implement mechanism 1300 when computer system 400 is operating in the SEM. SAT entry buffer 1704 is similar to SAT entry buffer 802 of the CPU SCU 416 described above, and is used to store a relatively small number of SAT entries 1225 of recently accessed memory pages.

When computer system 400 is operating in SEM, the security check logic 1700 of FIG. 17 may use additional security information of a SAT entry 1312 associated with a selected memory page to determine if a given hardware-initiated memory access is authorized. If the given hardware-initiated memory access is authorized, security check logic 1700 provides the memory access signals (i.e., address signals conveying a physical address and the associated control and/or data signals) of the memory access to memory controller 1604. Memory controller 1604 uses the physical address and the associated control and/or data signals to access memory 406. If memory 406 access is a write access, data conveyed by the data signals is written to memory 406. If memory 406 access is a read access, memory controller 1604 reads data from memory 406, and provides the resulting read data to security check logic 1700. Security check logic 1700 forwards the read data to bridge logic 1602, and bridge logic 1602 provides the data to device bus interface 1606.

If, on the other hand, the given hardware-initiated memory access is not authorized, security check logic 1700 does not provide the physical address and the associated control and/or data signals of memory 406 accesses to memory controller 1604. If the unauthorized hardware-initiated memory access is a memory write access, security check logic 1700 may signal completion of the write access and discard the write data, leaving memory 406 unchanged. Security check logic 1700 may also create a log entry in a log (e.g., set or clear one or more bits of a status register) in order to document the security access violation. Security kernel 504 may periodically access the log to check for such log entries. If the unauthorized hardware-initiated memory access is a memory read access, security check logic 1700 may return a false result (e.g., all “F”s) to device bus interface 1606 via bridge logic 1602 as the read data. Security check logic 1700 may also create a log entry as described above in order to document the security access violation.

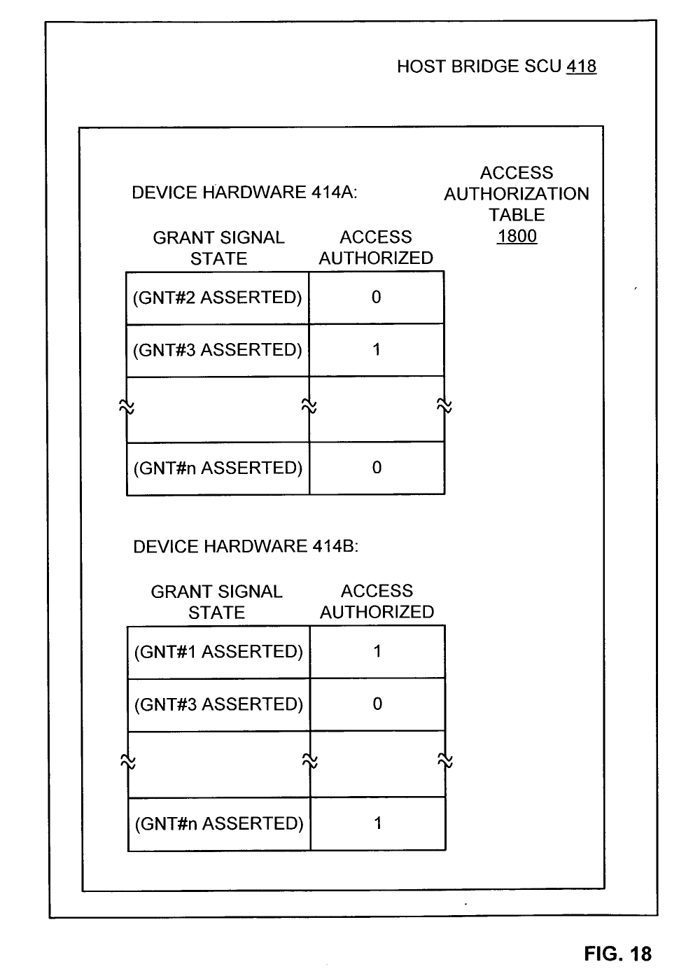

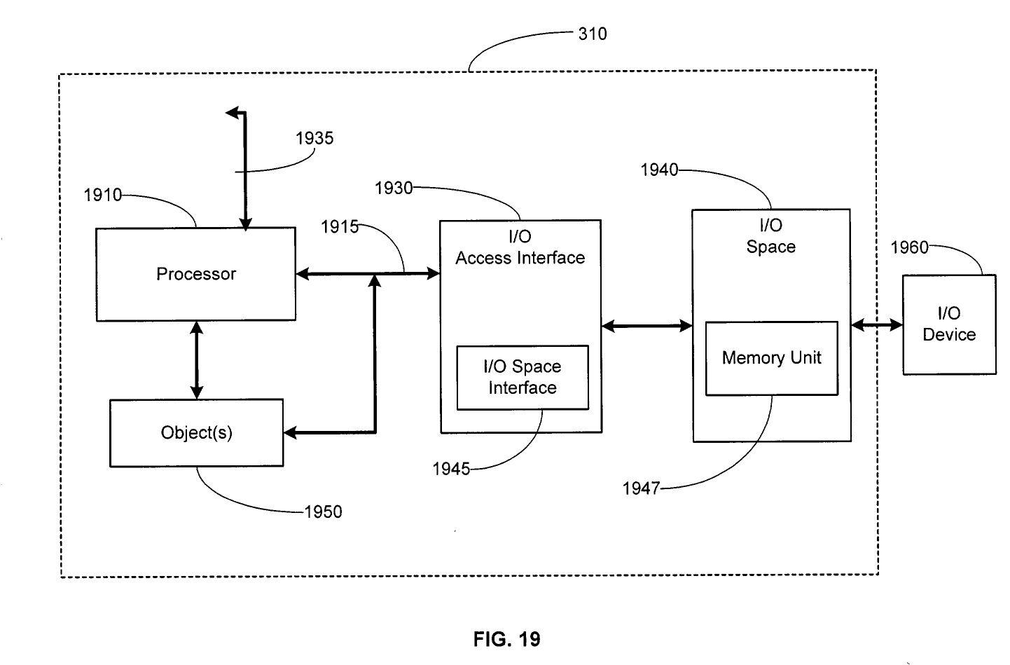

FIG. 18 is a diagram of another embodiment of host bridge SCU 418, wherein the host bridge SCU 418 includes an access authorization table 1800. In general, access authorization table 1800 has a different set of entries for each device coupled to device bus 408 and capable of driving device bus 408 (i.e., each device having associated REQ# and GNT# signals). A first set of entries corresponding to device hardware 414A and a second set of entries associated with device hardware 414B are shown in FIG. 18. Additional sets of entries are also contemplated.

Each entry of access authorization table 1800 corresponds to a device coupled to device bus 408 and capable of driving device bus 408. For example, in FIG. 18, a first entry in the first set of entries corresponding to device hardware 414A is directed to device hardware 414B. The first entry includes a “GRANT SIGNAL STATE” field containing the phrase “(GNT#2 ASSERTED)”, indicating that the first entry applies when the GNT#2 signal is asserted. The first entry also includes an “ACCESS AUTHORIZED” value corresponding to device hardware 414B and indicating whether or not device hardware 414B is authorized to access device hardware 414A. Access authorization table 1800 may be created and maintained by the security kernel 504.

According to the PCI bus protocol, an “initiator” device accesses a “target” device to initiate a bus transfer or “transaction.” The target device may terminate the transaction by asserting a STOP# signal. When the initiator device detects the asserted STOP# signal, the initiator device must terminate the transaction and re-arbitrate for control of the PCI bus in order to complete the transaction. If the target device asserts the STOP# signal before any data is transferred, the termination is called a “retry.”

In an embodiment where the device bus 408 is a PCI bus, device bus 408 includes multiplexed address and data (A/D) signal lines. An initiator device coupled to device bus 408 accesses a target device coupled to device bus 408 by driving the multiplexed A/D signal lines of device bus 408 with address signals conveying an address assigned to the target device. In order to control access to, for example, device hardware 414B coupled to device bus 408, host bridge SCU 418 first programs device hardware 414B via the PCI bus to configure device hardware 414B to respond to all access attempts by asserting the STOP# signal (i.e., to block all access attempts by initiating a PCI bus retry).

Host bridge SCU 418 is coupled to signal lines of device bus 408 via device bus interface 1606, and monitors the GNT# and A/D signal lines of device bus 408 to detect device access attempts. Assume, for example, device hardware 414A attempts to access device hardware 414B. When “initiator” device hardware 414A attempts to access “target” device hardware 414B, device hardware 414B blocks the access attempt by initiating a PCI bus retry (i.e., asserting the STOP# signal after detecting an address assigned to device hardware 414B on the A/D signal lines of device bus 408). This action forces device hardware 414A to retry the access attempt via a subsequent access attempt.

While device hardware 414B blocks the access attempt, host bridge SCU 418 detects the access attempt via the address assigned to device hardware 414B driven on the A/D signal lines of device bus 408. As device hardware 414A has control of device bus 408, the GNT#1 signal is asserted, and host bridge SCU 418 identifies device hardware 414A as the initiator via the asserted GNT#1 signal.

The host bridge SCU 418 then determines if the subsequent access attempt by device hardware 414A should be allowed. The host bridge SCU 418 accesses the second set of entries access authorization table 1800 corresponding to device hardware 414B, and selects the first entry of the second set having “(GNT#1 ASSERTED)” in the GRANT SIGNAL STATE field. The ACCESS AUTHORIZED value of the first entry is a ‘1’ indicating access of device hardware 414B by device hardware 414A is authorized, and the subsequent access attempt by device hardware 414A should be allowed.

As the ACCESS AUTHORIZED value indicates the subsequent access attempt by device hardware 414A should be allowed, host bridge SCU 418 sends a signal to bus arbiter 1608 identifying device hardware 414A. Immediately prior to the next granting of control of device bus 408 to device hardware 414A, bus arbiter 1608 grants control of device bus 408 to host bridge SCU 418. Host bridge SCU 418 drives signals on the signal lines of device bus 408 which configure device hardware 414B to allow the subsequent access attempt by device hardware 414A.

Immediately following the subsequent access attempt by device hardware 414A, bus arbiter 1608 again grants control of device bus 408 to host bridge SCU 418. Host bridge SCU 418 drives signals on the signal lines of the PCI bus which configure device hardware 414B to respond to all access attempts by initiating a PCI bus retry (i.e., to block all access attempts by asserting the STOP# signal after detecting an address assigned to device hardware 414B on the A/D signal lines of device bus 408).

Where an ACCESS AUTHORIZED value in a selected entry of access authorization table 1800 is a ‘0’ indicating an initiator device is not authorized to access a target device and the subsequent access attempt by the initiator device should not be allowed, host bridge SCU 418 does not configure the target device to allow the subsequent access attempt by the initiator device, and the target device continues to block access attempts by the initiator device by initiating PCI bus retries. It is noted that the above described atomic configure-access-configure mechanism requires only that an existing PCI device be programmable to initiate a PCI bus retry in order to be protected.

Turning now to FIG. 19, a simplified block diagram of one embodiment of the processing unit 1910 in accordance with the present invention, is illustrated. The processing unit 310 in one embodiment, comprises a processor 1910, an I/O access interface 1920, an I/O space 1940, and programmable objects 1950, such as software objects or structures. The processor 1910 may be a microprocessor (e.g., CPU 420), and may comprise a plurality of processors (not shown).

In one embodiment, the I/O space 1940 provides a “gateway” to an I/O device 1960, such as a modem, disk drive, hard-disk drive, CD-ROM drive, DVD-drive, PCMCIA card, and a variety of other input/output peripheral devices (e.g., 414A-414D). In an alternative embodiment, the I/O space 1940 is integrated within the I/O device 1960. In one embodiment, the I/O space 1940 comprises a memory unit 1947 that contains data relating to addressing and communicating with the I/O space 1940. The memory unit 1947 comprises a physical memory section, that comprises physical memory such as magnetic tape memory, flash memory, random access memory, memory residing on semiconductor chips, and the like. The memory residing on semiconductor chips may take on any of a variety of forms, such as a synchronous dynamic random access memory (SDRAM), double-rate dynamic random access memory (DDRAM), or the like.

The processor 1910 communicates with the I/O space 1940 through the system I/O access interface 1920. In one embodiment, the I/O access interface 1920 is of a conventional construction, providing I/O space addresses and logic signals to the I/O space 1940 to characterize the desired input/output data transactions. Embodiments of the present invention provides for the I/O access interface 1920 to perform a multi-table, security-based access system.

The processor 1910, in one embodiment is coupled to a host bus 1915. The processor 1910 communicates with the I/O access interface 1920 and the objects 1950 via the host bus 1915. The I/O access interface 1920 is coupled to the host bus 1915 and the I/O space 1940. The processor 1910 is also coupled to a primary bus 1925 that is used to communicate with peripheral devices. In one embodiment, the primary bus 1925 is a peripheral component interconnect (PCI) bus (see PCI Specification, Rev. 2.1). A video controller (not shown) that drives the display unit 220 and other devices (e.g., PCI devices) are coupled to the primary bus 1925. The computer system 200 may include other buses such as a secondary PCI bus (not shown) or other peripheral devices (not shown) known to those skilled in the art.

The processor 1910 performs a plurality of computer processing operations based upon instructions from the objects 1950. The objects 1950 may comprise software structures that prompt the processor 1910 to execute a plurality of functions. In addition, a plurality of subsections of the objects 1950, such as operating systems, user-interface software systems, such as Microsoft Word®, and the like, may simultaneously reside and execute operations within the processor 1910. Embodiments of the present invention provide for a security level access and privilege for the processor 1910.

In response to execution of software codes provided by the objects 1950, the processor 1910 may perform one or more I/O device accesses, including memory accesses, in order to execute the task prompted by the initiation of one or more objects 1950. The I/O access performed by the processor 1910 may include accessing I/O devices 1960 to control the respective functions of the I/O devices 1960, such as the operation of a modem. The I/O access performed by the processor 1910 also may include accessing memory locations of I/O devices 1960 for storage of execution codes and memory access to acquire data from stored memory locations.

Many times, certain I/O devices 1960, or portions of I/O devices 1960 may be restricted for access by one or more selected objects 1950. Likewise, certain data stored in particular memory locations of I/O devices 1960 may be restricted for access by one or more selected objects 1950. Embodiments of the present invention provide for multi-table security access to restrict access to particular I/O devices 1960, or memory locations of I/O devices 1960, in the system 200. The processor 1910 performs I/O space access via the I/O access interface 1920. The I/O access interface 1920 provides access to the I/O space 1940, which may comprise a gateway to a plurality of I/O devices 1960. A multi-table virtual memory access protocol is provided by at least one embodiment of the present invention.

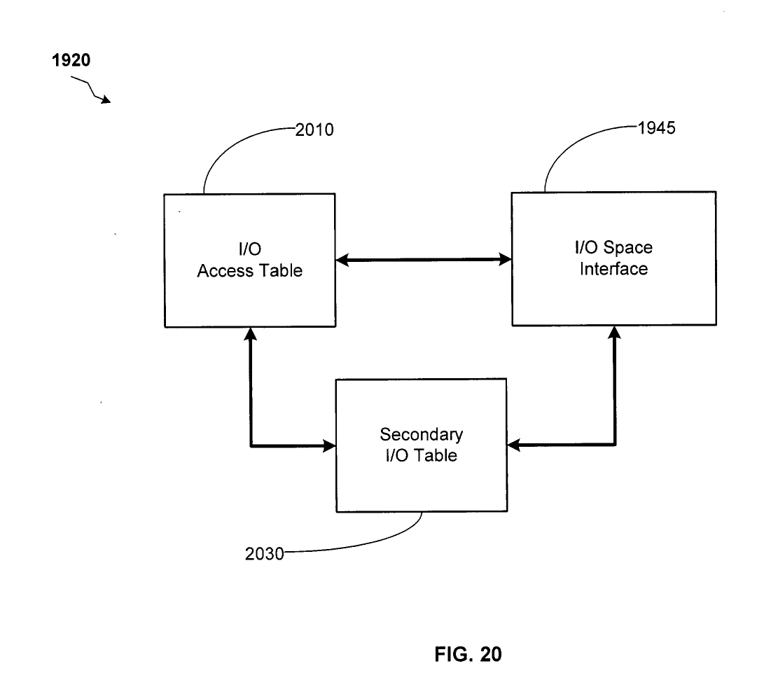

Turning now to FIG. 20, a block diagram depiction of one embodiment of the I/O access interface 1920 in accordance with the present invention, is illustrated. In one embodiment, the I/O access interface 1920 comprises an I/O access table 2010, a secondary I/O table 2030, and an I/O space interface 1945. In one embodiment, the I/O space interface 1945 represents a “virtual” I/O space address that can be used to address a physical location relating to an I/O device 1960, or to a portion of an I/O device 1960. The processor 1910 can access the I/O space 1940 by addressing the I/O space interface 1945.

Embodiments of the present invention provide for performing I/O access using a multi-table I/O and memory access system. The multi-table I/O and memory access system utilized by embodiments of the present invention use a multilevel table addressing scheme (i.e., using the I/O access table 2010 in conjunction with the secondary I/O table 2030) to access I/O space addresses via the I/O space interface 1945. The I/O memory addresses are used by the processor 1910 to locate the desired physical I/O location.

The system 300 may utilize the I/O access table 2010 in combination with one or more other tables, such as the secondary I/O table 2030, to define a virtual I/O space address. The I/O access table 2010 and the secondary I/O access tables 2030 are used to translate virtual I/O space addresses that lead to a physical I/O address. The physical I/O address points to a physical location of an I/O device 360 or to a memory location in the I/O device 1960. The multi-level I/O access table system provided by embodiments of the present invention allows the secondary I/O table 2030 to define entire sections of the I/O access table 2010. In some instances, the secondary I/O table 2030 may define a portion of a virtual I/O address that may not be present in the I/O access table 2010. The secondary I/O table 2030 can be used as a fine-tuning device that further defines a physical I/O location based upon a virtual I/O address generated by the I/O access table 2010. This will result in more accurate and faster virtual I/O address definitions.

In one embodiment, the secondary table 2030, which may comprise a plurality of sub-set tables within the secondary table 2030, is stored in the memory unit 1947, or the main memory (not shown) of the system 300. The secondary I/O tables 2030 are stored at high security levels to prevent unsecured or unverified software structures or objects 1950 to gain access to the secondary I/O table 2030. In one embodiment, the processor 1910 requests access to a location in a physical I/O device location based upon instructions sent by an object 1950. In response to the memory access request made by the processor 1910, the I/O access interface 1920 prompts the I/O access table 2010 to produce a virtual I/O address, which is further defined by the secondary I/O table 2030 The virtual I/O address then points to a location in the I/O space interface 1945. The processor 1910 then requests an access to the virtual I/O location, which is then used to locate a corresponding location in the I/O device 1960.

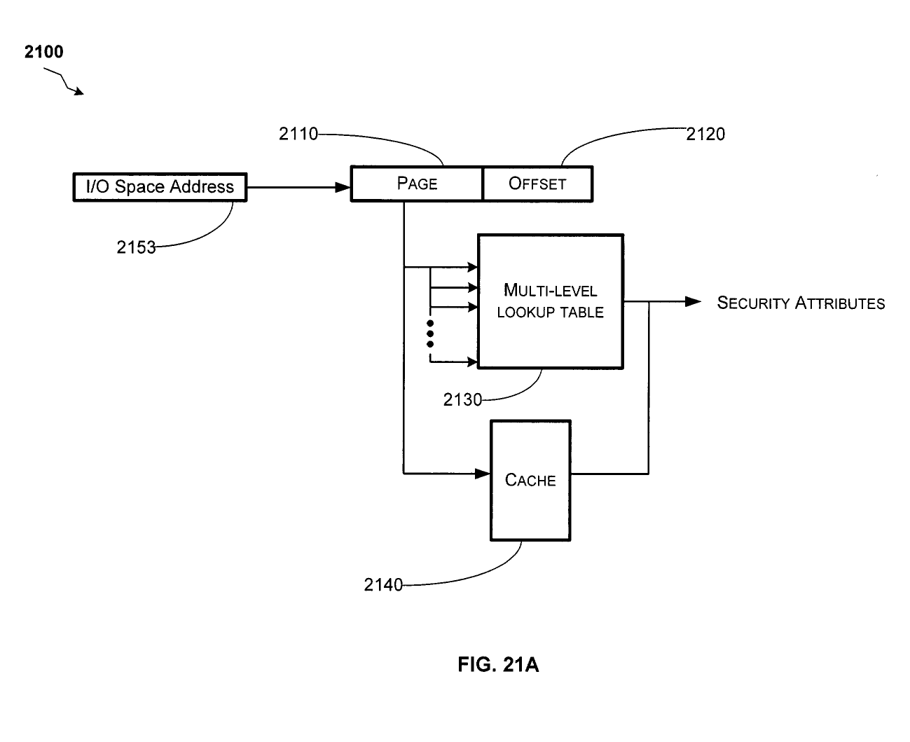

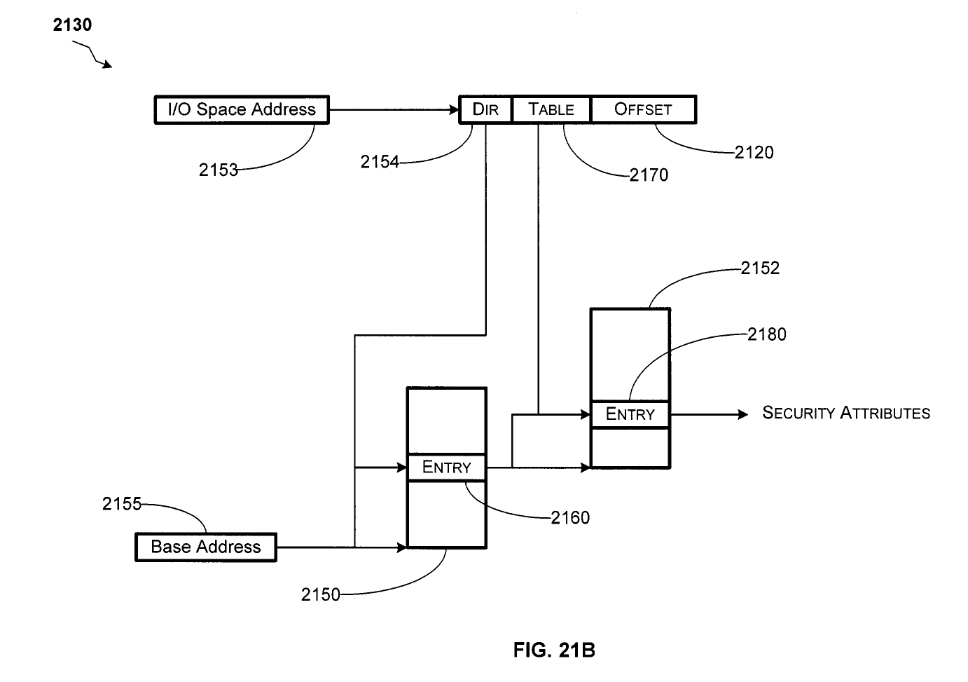

One embodiment of performing the memory access performed by the processor 1910, is illustrated in FIG. 21A, FIG. 21B, and by the following description. Turning now to FIG. 21A, one illustrative embodiment of an I/O access system 2100 for storing and retrieving security level attributes in a data processor or system 300 is shown. In one embodiment, the I/O access system 2100 is integrated into the processing unit 1910 in the system 300. The I/O access system 2100 is useful in a data processor (not shown) that uses a multi-table security scheme for accessing I/O space 1940. For example, the I/O access system 2100 may be used by the processor 1910 when addressing I/O space 1940 using the paging scheme, such as paging schemes implemented in x86 type microprocessors. In one embodiment, a single memory page in an x86 system comprises 4 kilobytes of memory. Moreover, the I/O access system 2100 finds particular applications in the processor 1910 that assigns appropriate security level attributes at the page level.

The I/O access system 2100 receives an I/O space address 2153 that is composed of a page portion 2110 and an offset portion 2120, as opposed to a virtual, linear, or intermediate address that would be received by a paging unit in an x86 type microprocessor. In one embodiment, the page portion 2110 data addresses an appropriate memory page, while the offset portion 2120 data addresses a particular offset I/O location within the selected page portion 2110. The I/O access system 2100 receives the physical address, such as would be produced by a paging unit (not shown) in an x86 type microprocessor.

A multi-level lookup table 2130, which is generally referred to as the extended security attributes table (ESAT), receives the page portion 2110 of the physical I/O address. The multi-level lookup table 2130 stores security attributes associated with each page 2110 of memory. In other words, each page 2110 has certain security level attributes associated with that page 2110. In one embodiment, the security attributes associated with the page 2110 is stored in the multi-level lookup table 2130. For example, the security attributes associated with each page 2110 may include look down, security context ID, lightweight call gate, read enable, write enable, execute, external master write enable, external master read enable, encrypt memory, security instructions enabled, etc. Many of these attributes are known to those skilled in the art having benefit of the present disclosure.

In one embodiment, the multi-level lookup table 2130 is located in the system memory (not shown) of system 300. In an alternative embodiment, the multi-level lookup table 2130 is integrated into the processor 1910, which includes a microprocessor that employs the system 300. Accordingly, the speed at which the multi-level lookup table 2130 is capable of operating is, at least in part, dependent upon the speed of the system memory. The speed of the system memory, as compared to the speed of the processor 310, is generally relatively slow. Thus, the process of retrieving the security attributes using the multi-level lookup table 2130 may slow the overall operation of the system 300. To reduce the period of time required to locate and retrieve the security attributes, a cache 2140 is implemented in parallel with the multi-level lookup table 2130. The cache 2140 may be located on the same semiconductor die as the processor 1910 (i.e., the cache 2140 and the processor 1910 being integrated on one semiconductor chip) or external to the processor die or both. Generally, the speed of the cache 2140 may be substantially faster than the speed of the multi-level lookup table 2130. The cache 2140 contains smaller subsets of the pages 2110 and their security attributes contained within the multi-level lookup table 2130. Thus, for the pages 2110 stored in the cache 2140, the operation of retrieving the security attributes may be substantially enhanced.

Turning now to FIG. 21B, one embodiment of the multi-level lookup table 2130 used for storing and retrieving the security attributes associated with a page 2110 in memory is illustrated. The multi-level lookup table 2130 comprises a first table 2150, which is generally referred to as an ESAT directory, and a second table 2152, which is generally referred to as the ESAT. Generally, the first table 2150 contains a directory of starting addresses for a plurality of ESATs 2152 in which the security attributes for each of the pages 2110 is stored. In the embodiment illustrated herein, a single ESAT directory 2150 may be used to map the entire range of I/O addresses and/or memory within the I/O devices 1960.

A first portion of the I/O space address 2153, which includes the highest order bits and is generally referred to as the directory (DIR) 2154, is used as a pointer into the first table 2150. The I/O space address 2153 may also comprise a portion that contains table data 2170, which can identify the table 2150, 2152 being addressed. The I/O space address 2153 further comprises the offset 2120 within a table 2150, 2152 that leads to a particular entry 2160, 2180. The first table 2150 is located in the system memory at a base address 2155. The DIR portion 2154 of the I/O space address 2153 is added to the base address 2155 to identify an entry 2160, which points to a base address of an appropriate address in one of the second tables 2152. In one embodiment, a plurality of the second tables 2152 may be present in the multi-level lookup table 2130. Generally, each one of the entries 2160 in the first table 2150 points to a starting address of one of the addresses in the second tables 2152. In other words, each entry 2180 may point to its own separate ESAT 2152.

In one embodiment, the first table 2150 and each of the second tables 2152 occupy one page 2110 in physical memory. Thus, a conventional memory management unit in an x86 type microprocessor with paging enabled is capable of swapping the tables 2150, 2152 in and out of the system memory, as needed. That is, because of the multi-level arrangement of the tables 2150, 2152, it is desirable that all of the tables 2152 to be simultaneously present in the I/O space 340. If one of the tables 2152 that is not currently located in the memory unit 1947 is requested by an entry 2160 in the first table 2150, the conventional memory management unit (not shown) of the x86 microprocessor may read the page 2110 from main memory, such as a hard disk drive, and store the requested page 2110 in the system memory where it may be accessed. This one-page sizing of the tables 2150, 2152 reduces the amount of system memory needed to store the multi-level lookup table 2130, and reduces the amount of memory swapping needed to access I/O space 1940 using the tables 2150, 2152.

In one embodiment, each page is 4 kilobytes in size, and the system memory totals 16 megabytes or more. Thus, approximately 4000 ESAT tables 2152 may reside within a page 2110. In one embodiment, the 4000 ESAT tables 2152 each may contain 4000 sets of security attributes. Furthermore, the ESAT directory 2150 contains the starting address for each of the 4000 ESAT tables 2152. The entry 2160 of the first table 2150 points to the base address of the appropriate second table 2152. A desired entry 2180 in the appropriate second table 2152 is identified by adding a second portion 2152 (the table portion) of the I/O space address 2153 to the base address 2155 contained in the entry 2160. In one embodiment, the entry 2180 contains predetermined security attributes associated with the identified page 2110 in the I/O space 340. The multi-table scheme illustrated in FIGS. 21A and 21B is an illustrative embodiment, those skilled in the art having benefit of the present disclosure may implement a variety of multi-table schemes in accordance with the present invention.

FIG. 22 is a diagram illustrating one embodiment of the SEM I/O permission bitmap, labeled 2200 in FIG. 22, and one embodiment of a mechanism for accessing the SEM I/O permission bitmap 2200. The mechanism of FIG. 22 may be embodied within the logic within the BIU 406, and may apply when the computer system 400 is operating in the SEM. In FIG. 22, the set of SEM registers 610 includes a model specific register (MSR) 2202. The MSR 2202 is used to store a beginning (i.e., base) address of the SEM I/O permission bitmap 2200. As described above, the computer system 400 has n different SCID values, where n is an integer and n≧1. The SEM I/O permission bitmap 2200 includes a different I/O permission bitmap for each of the n different SCID values. Each of the separate I/O permission bitmaps include 64 bits, or 8 k bytes.

In the embodiment of FIG. 22, the SCID value of the memory page including the I/O instruction that accesses the I/O port is used as a offset from the contents of the model specific register 2202 (i.e., the base address of the SEM I/O permission bitmap 2200) into the one or more 64 k-bit (8 k-byte) I/O permission bitmaps making up the SEM I/O permission bitmap 2200. As a result, the I/O permission bitmap corresponding to the SCID value is accessed. The I/O port number is then used as a bit offset into the I/O permission bitmap corresponding to the SCID value. The bit accessed in this manner is the bit corresponding to the I/O port defined by the I/O port number.

FIG. 23 is a diagram illustrating another embodiment of the SEM I/O permission bitmap, labeled 2300 in FIG. 23, and another embodiment of the mechanism for accessing the SEM I/O permission bitmap. The mechanism of FIG. 23 may be embodied within the logic within the BIU 406. In the embodiment of FIG. 23, the SEM I/O permission bitmap 2300 includes a single 64 k-bit (8 k-byte) I/O permission bitmap. The I/O port number is used as a bit offset from the contents of the model specific register 2202 (i.e., the base address of the secure execution mode I/O permission bitmap 2200) into the I/O permission bitmap. The bit accessed in this manner is the bit corresponding to the I/O port defined by the I/O port number. Note that unless otherwise indicated, the SEM I/O permission bitmap 2200 and the SEM I/O permission bitmap 2300 are interchangeable.

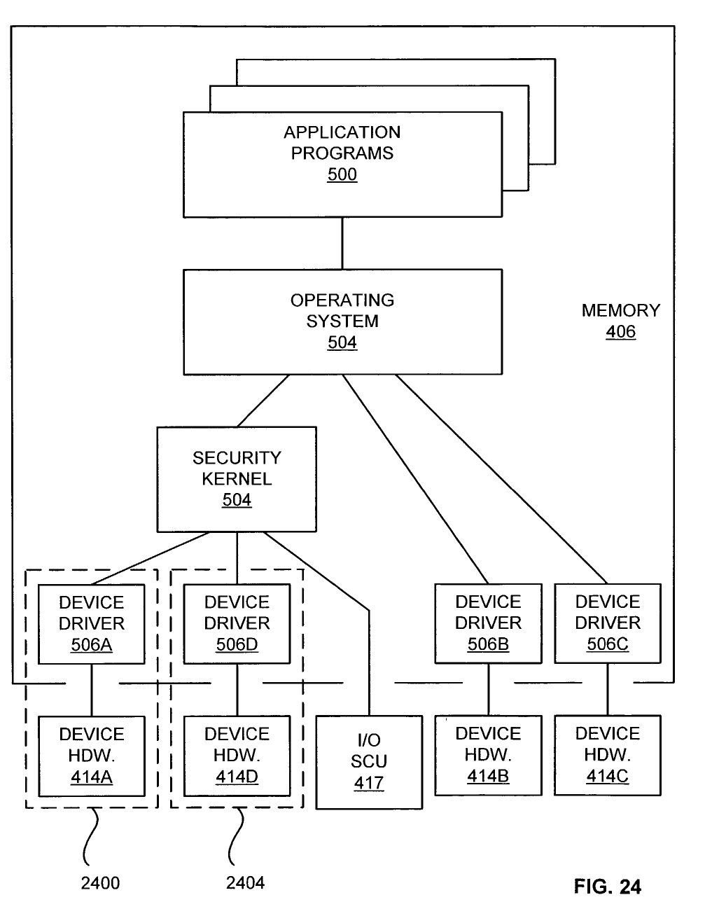

FIG. 24 may be used to describe how the assignment of the SCID values, and the creations of corresponding SEM I/O permission bitmaps 2200, 2300, serves to “compartmentalize” device drivers and associated device hardware units within the computer system 400 for security purposes. FIG. 24 is a diagram illustrating relationships between various hardware and software components of the computer system 400, similar to FIG. 5B, wherein the device driver 506A and the corresponding device hardware unit 414A reside in a first security “compartment” 2400, and the device driver 506D and the corresponding device hardware unit 414D reside in a second security compartment 2404. The security compartments 2400 and 2404 are separate from, and operationally isolated from, each other. Only the device driver 506A is allowed to access the device hardware unit 414A, and only the device driver 506D is allowed to access the device hardware unit 414D. This “compartmentalization” of device drivers and associated device hardware units helps prevent malicious or errant code from negatively affecting the state of the device hardware units, or interfering with proper operation of the computer system 400.

For example, in the embodiment of FIG. 24, the memory pages including instructions of the device drivers 506A and 506D may be assigned different SCID values. A first SEM I/O permission bitmap 2200, 2300 created for the SCID value of the device driver 506A may allow the device driver 506A to access to a first portion of an I/O address space of the computer system 400 assigned to the device hardware unit 414A, and may not allow the device driver 506A to access to a second portion of the I/O address space assigned to the device hardware unit 414D. Similarly, a second SEM I/O permission bitmap 2200, 2300 created for the SCID value of the device driver 506D may allow the device driver 506D to access to the second portion of the I/O address space assigned to the device hardware unit 414D, and may not allow the device driver 506A to access to the first portion of the I/O address space assigned to the device hardware unit 414A. As a result, only the device driver 506A is allowed to access the device hardware unit 414A, and only the device driver 506D is allowed to access the device hardware unit 414D.

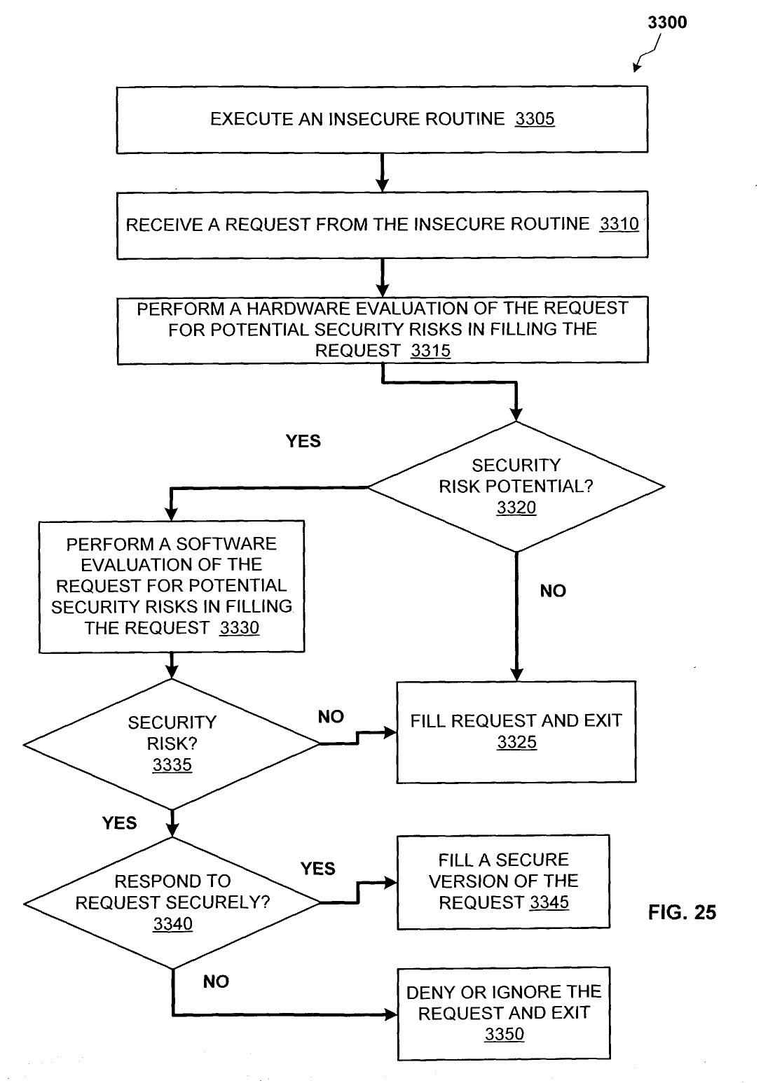

In light of the aforementioned system 300 and the various features described with respect thereto, an embodiment of a method 3300 of operating the computer system 400, in any of its embodiments, is illustrated in FIG. 25. The method 3300 includes executing an insecure routine, in block 3305. The insecure routine may be a typical software routine that does not require security protocols for operation. The insecure routine may also be a software routine with minimal security protocols. The insecure routine may include an operating system call.

The method 3300 also includes receiving a request from the insecure routine, in block 3310. The request may include, for example, a memory transaction, an I/O transaction, a device-to-device transaction, or a software routine. The request typically would be met with an expected response by the computer system 400. The method 3300 performs a first evaluation of the request in hardware, in block 3315. The first evaluation may include a characterization or other broad potential security risk decision. The first evaluation may flag requests that are not true security risks, but fall within a category or a transaction type that include possible or potential security risks.

The method 3300 next determines if the request is a potential security risk, in decision block 3320. If the request is not seen as a potential security risk in decision block 3320, then the method 3300 fills the request, in block 3325. The request may be filled so as to minimize any security risks and/or to maximize the response time of the computer system 400. If the request is seen as a potential security risk in decision block 3320, then the method 3300 performs a more detailed second evaluation in software, in block 3330. The second evaluation includes a more thorough evaluation of the request and any potential security risks in filling the request with the expected response.

The method 3300 next determines if the request is seen as a security risk, in decision block 3335. If the request is not seen as a security risk in decision block 3335, then the method 3300 fills the request, in block 3325. The request may be filled so as to minimize any security risks and/or to maximize the response time of the computer system 400. If the request is seen as a security risk in decision block 3335, then the method 3300 determines if the risk is manageable using one or more of the aspects of the present invention described herein so the request can be responded to securely, in decision block 3340. If the security risk in filling the request is seen as manageable, in decision block 3340, then the method 3300 fills a secure version of the request, in block 3345. In one embodiment, the response is performed by virtualization, with the insecure routine receiving no indication that the request was not filled as requested. The request is instead filled by a software construct that allows the computer system 400 to trap or contain security problems associated with the request. If the security risk in filling the request is seen as unmanageable, then the method 3300 denies or ignores the request, in block 3350. The method 3300 may also respond to the request with a dummy or predetermined response.

The first evaluation, in block 3315, may be advantageously performed quickly in hardware. The second evaluation, in block 3330, may be advantageously performed more thoroughly in software. The software evaluation may also be easily upgraded as new security risk algorithms are developed.

The following requests and possible secure responses are examples only and not intended to limit any particular claim. Consider a request to write to a memory page that includes confidential data that have been secured. The write cannot be allowed as requested. The memory page may be virtualized into a virtual page and the write allowed to the virtual page. The computer system 400 can then evaluate the changes to the virtual page.

Consider next a request for a write to a protected register. The protected register may be virtualized into a virtual register. The write can be allowed to the virtual register and evaluated for security risks. Consider also a request to modify the real-time clock. The real-time clock may be virtualized into a virtual clock. The request may be filled for the insecure routine without changing the real-time clock.

Some aspects of the invention as disclosed above may be implemented in hardware or software. Thus, some portions of the detailed descriptions herein are consequently presented in terms of a hardware implemented process and some portions of the detailed descriptions herein are consequently presented in terms of a software-implemented process involving symbolic representations of operations on data bits within a memory of a computing system or computing device. These descriptions and representations are the means used by those in the art to convey most effectively the substance of their work to others skilled in the art using both hardware and software. The process and operation of both require physical manipulations of physical quantities. In software, usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software-implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A computer system, comprising:
a processor configurable to execute a secure routine and an insecure routine; and
hardware coupled to perform a first evaluation of a request associated with the insecure routine, wherein the hardware is further configured to provide a notification of the request to the secure routine;
wherein the secure routine is configured to perform a second evaluation of the request, and wherein the secure routine is further configured to deny a requested response to the request.

2. The computer system of claim 1, wherein the secure routine includes a software security exception handler configured to perform the second evaluation of the request.

3. The computer system of claim 2, wherein if the request passes the second evaluation, then the software security exception handler is configured to allow the requested response.

4. The computer system of claim 1, wherein the secure routine includes a software security exception handler configured to allow the requested response if the request passes the second evaluation.

5. The computer system of claim 1, wherein the processor is configured to execute x86 instructions.

6. The computer system of claim 1, wherein the secure routine is a component of a secure kernel.

7. The computer system of claim 6, wherein the secure kernel is a component of an operating system.

8. The computer system of claim 1, wherein the insecure routine includes an operating system call.

9. The computer system of claim 1, wherein the first evaluation is a categorization, and wherein the second evaluation is a security risk evaluation.

10. The computer system of claim 9, wherein the categorization includes comparing the request to a plurality of categories including categories with minimal security risk and categories with potentially high security risk, and wherein the hardware notifies the secure routine of the request if the request is in one of the categories with potentially high security risk.

11. The computer system of claim 1, wherein the hardware includes a secure execution mode register storing at least a secure execution mode bit.

12. The computer system of claim 1, wherein the hardware includes a memory storing an I/O protection bitmap.

13. The computer system of claim 1, wherein the hardware includes a memory storing a security data structure.

14. The computer system of claim 1, wherein the notification includes a hardware exception.

15. The computer system of claim 1, wherein the secure routine includes at least one of microcode and a finite state machine.

16. A method, comprising:
executing an insecure routine;
receiving a request from the insecure routine;
performing a first evaluation of the request in hardware; and
performing a second evaluation of the request in a secure routine in software.

17. The method of claim 16, wherein performing the second evaluation of the request in the secure routine in software comprises performing the second evaluation of the request in a software security exception handler.

18. The method of claim 16, wherein executing the insecure routine comprises executing the insecure routine comprised of x86 instructions.

19. The method of claim 16, wherein performing the second evaluation of the request in the secure routine in software comprises performing the second evaluation of the request in a secure kernel.

20. The method of claim 19, wherein performing the second evaluation of the request in the secure kernel comprises performing the second evaluation of the request in an operating system.

21. The method of claim 16, wherein executing the insecure routine comprises executing an operating system component, and wherein receiving the request from the insecure routine comprises receiving an operating system call.

22. The method of claim 16, wherein performing the first evaluation of the request in hardware comprises performing a categorization of the request in hardware; and wherein performing the second evaluation of the request in the secure routine in software comprises performing a security risk evaluation of the request in the secure routine in software.

23. The method of claim 22, wherein performing the categorization of the request in hardware comprises comparing the request to a plurality of categories including categories with little security risk and categories with potential security risk; and the hardware passing the request to the secure routine if the request is in one of the categories with potential security risk.

24. A system, comprising:
means for executing an insecure routine;
means for receiving a request from the insecure routine;
means for performing a first evaluation of the request in hardware; and
means for performing a second evaluation of the request in a secure routine in software.

25. The system of claim 24, wherein the means for performing the second evaluation of the request in the secure routine in software comprises means for performing the second evaluation of the request in a software security exception handler.

26. The system of claim 24, wherein the means for executing the insecure routine comprises means for executing the insecure routine comprised of x86 instructions.

27. The system of claim 24, wherein the means for performing the second evaluation of the request in the secure routine in software comprises means for performing the second evaluation of the request in a secure kernel.

28. The system of claim 27, wherein the means for performing the second evaluation of the request in the secure kernel comprises means for performing the second evaluation of the request in an operating system.

29. The system of claim 24, wherein the means for executing the insecure routine comprises means for executing an operating system component, and wherein the means for receiving the request from the insecure routine comprises means for receiving an operating system call.

30. The system of claim 24, wherein the means for performing the first evaluation of the request in hardware comprises means for performing a categorization of the request in hardware; and wherein the means for performing the second evaluation of the request in the secure routine in software comprises means for performing a security risk evaluation of the request in the secure routine in software.

31. The system of claim 30, wherein the means for performing the categorization of the request in hardware comprises means for comparing the request to a plurality of categories including categories with little security risk and categories with potential security risk; and the hardware passing the request to the secure routine if the request is in one of the categories with potential security risk.

32. A machine readable medium encoded with instructions that, when executed by a computer system, perform a method, the method comprising:
executing an insecure routine;
passing a request from the insecure routine to hardware;
receiving the request from the hardware after a first evaluation; and
performing a second evaluation of the request in a secure routine.

33. The machine readable medium of claim 32, wherein performing the second evaluation of the request in the secure routine comprises performing the second evaluation of the request in a software security exception handler.

34. The machine readable medium of claim 32, wherein executing the insecure routine comprises executing the insecure routine comprised of x86 instructions.

35. The machine readable medium of claim 32, wherein performing the second evaluation of the request in the secure routine comprises performing the second evaluation of the request in a secure kernel.

36. The machine readable medium of claim 35, wherein performing the second evaluation of the request in the secure kernel comprises performing the second evaluation of the request in an operating system.

37. The machine readable medium of claim 32, wherein executing the insecure routine comprises executing an operating system component, and wherein passing the request from the insecure routine to hardware comprises generating a hardware interrupt.
